(19) United States
(12) Patent Application Publication
(10) Pub. No.: US 2023/0230187 A1
(43) Pub. Date: Jul. 20, 2023

(54) METHODS FOR VALIDATING THE VERACITY OF A COMPLETED TASK

(71) Applicant: Unira, Inc., Miami, FL (US)

(72) Inventors: Jeremy Gallego Eckstein, Miami, FL (US); Cariel Cohen, Boca Raton, FL (US)

(21) Appl. No.: 18/122,263

(22) Filed: Mar. 16, 2023

Related U.S. Application Data
(63) Continuation-in-part of application No. 18/095,974, filed on Jan. 11, 2023.
(60) Provisional application No. 63/299,642, filed on Jan. 14, 2022.

(51) Int. Cl. G06Q 50/20; G06Q 10/0639

(52) U.S. Cl. CPC G06Q 50/205; G06Q 10/06395

(57) ABSTRACT

A computer implemented method for determining the veracity of a completed task for validating the completed task towards the progression of a goal is disclosed. The completed task is a medical procedure performed by a first party. The goal is to compile a predetermined number of completed tasks required by a third party. The method includes receiving and storing registration data from a first party, second party, and third party. The method receives medical case information from the first party. The method causes an SMS message to be sent to the second party for soliciting approval of the case data. If an approval is received, then the method generates a validated medical case record. The method stores the validated medical case record to the blockchain and mints a token associated with the validated medical case. The method tracks the progression towards the goal based on validated medical cases.

### CROSS-REFERENCE TO RELATED APPLICATIONS

This application is a continuation in part of U.S. Non-Provisional application Ser. No. 18/095,974, filed Jan. 11, 2023, and which claims the priority benefit of U.S. Provisional Application Ser. No. 63/299,642, filed on Jan. 14, 2022, each of which the subject matter of which is herein incorporated by reference in its entirety.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of medical programs, and more specifically to the field of validating case procedures in a residency program.

### BACKGROUND

Once medical students graduate, they may enter a residency program in a teaching institution, or hospital, to start specialized training in a particular field of medicine. Residents may provide care to patients in the teaching institution and are supervised by an attending physician from the teaching institution. The attending physician is an expert medical doctor that has completed all residency training Each patient that a resident provides care to is considered a case that must be documented for the teaching institution. Each case is accredited by a third-party clearing house.

However, the current system of accrediting cases for the teaching institution has problems. A large percentage of input cases are inaccurate in some manner, whether it is date, procedure, duration, etc. A major issue is validating if residents have actually completed the cases that they have alleged they have completed. During residency, each resident must complete several cases. With many residents, the large number of cases to be reviewed is impossible for the residency program in the teaching institution to validate because the institution has to validate the veracity of the attributes of those cases, and if the students completed those cases. Difficulty in accurately confirming cases causes the institution to incorrectly accept cases from residents. Residents may incorrectly be given degrees if they have lied about or incorrectly input information of the cases that they allegedly completed. This source of fraud can cause institutions to lose credibility of their programs.

In many businesses or institutions, tasks by employees must be accurately recorded in order to avoid consequences that may lead to malpractice or more than expected costs and expenses. Without an effective process of validating completed tasks, businesses and institutions will continue to output a growing number of mistakes. The prior art fails to provide an immutable recordkeeping system that effectively prevents incorrect information and data from being stored.

As a result, there exists a need for improvements over the prior art and more particularly for a more efficient way of verifying the accuracy of completed tasks.

### SUMMARY

A system and method for determining the veracity of a completed task for validating the completed task towards the progression of a goal is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a computer implemented method for determining the veracity of a completed task for validating the completed task towards the progression of a goal is disclosed. The completed task is a medical procedure performed by a first party. The goal is to compile a predetermined number of completed tasks required by a third party. The computer implemented method being executed by one or more processors. The computer implemented method, being executed by one or more processors, comprises receiving resident registration data for generating a first party user record, receiving second party registration data for generating a second party user record, receiving third party registration data for generating a third party user record, and storing the first party user record, the second party user record, and the third party user record in a connected database. The first party registration data comprises a first unique identifier associated with the first party. Such first party registration data is input on a first computing device associated with the first party. The second party registration data comprises a second unique identifier associated with a second party. Such second party registration data is input on a second computing device associated with the second party. The third party registration data comprises unique task requirements associated with the third party. Such third party registration data is input on a second computing device associated with the third party. The computer implemented method also comprises receiving, prior to determining the veracity of the completed task, at the direction of the first party, task data from the computing device to generate a completed task record. The task data comprises a plurality of attributes of the completed task. The computer implemented method comprises, concurrently to receiving task data, receiving real-time input automatically generated from the computing device to generate a time stamp associated with the entry of the task data. The real-time input data comprises the date, time, and geolocation of the entry of the task data on the first computing device. The method further comprises determining if the time stamp is within a predetermined period of time after the completed task was performed. The predetermined period of time is based on the task data. After determining that the completed task was performed within the predetermined period of time, the method comprises causing an SMS message to be sent to the second computing device of the second party to determine the veracity of the completed task. The SMS message comprises at least a portion of the first party user record, the completed task record, and a solicitation to approve the completed task record. The method comprises receiving a reply SMS message from the second computing device. The reply SMS message comprises veracity data the defines an approval or a disapproval of the completed task record. The method further comprises, after determining that the approval was received, then generating a validated task record based on the reply SMS message. The method comprises storing the validated task record on a blockchain network and minting a token associated with the validated task. The computer implemented comprises sending the token to the first computing device of the first party. The computer implemented method comprises, after generating the validated task record, then generating a numerical score for the validated task record based on a plurality of predetermined scoring metrics. The computer implemented method comprises, after generating a numerical score for the validated task record, then calculating a user score based on the numerical score of the validated task record. The computer implemented method comprises generating a progress interface for displaying a progression status indicator on the first computing device. Generating the first user interface comprises generating a progression level towards the goal based on comparing the validated task record to the unique task requirements of the third party record. The computer implemented method comprises creating a plurality of tokens for a plurality of validated task records. The computer implemented method comprises tracking progression towards the goal by continuously updating the progression status bar on the first computing device. Updating the progression status bar comprises generating an updated progression level after processing each validated task record of the plurality of validated task records and generating an updated progress interface to be displayed on the first computing device. The computer implemented method comprises updating the first party score based on calculating an updated user score. The updated user score is based on processing each validated task record of the plurality of validated task records. The computer implemented method comprises generating an accreditation record for the first party when the goal is achieved. Achieving the goal comprises at least one of the first party score reaches a predetermined maximum user score; all unique task requirements of the accrediting user record have been satisfied by the plurality of validated task records of the first party; and the progression level reaches a predetermined maximum progression level. The computer implemented method comprises generating a graphical representation of the token for the validated task record. The computer implemented method comprises generating a second graphical representation of a wallet to be sent to the first computing device for displaying the graphical representation of the token. The computer implemented method comprises categorizing a plurality of tokens based on a plurality of validated attributes of a plurality of validated tasks. The categorizing comprises a plurality of predetermined groups that each correspond to a specific attribute of the plurality of attributes. The computer implemented method comprises, after determining that the disapproval was received, then receiving from the second computing device revised task data and generating the validated task record based on the revised task data. The revised task data comprises at least one change to at least one attribute of the plurality of attributes.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a diagram of an operating environment that supports a system for determining the veracity of a completed task for validating the completed task towards the progression of a goal, according to an example embodiment;

FIG. 2 is a schematic illustrating communication between the entities in FIG. 1 in relation to determining the veracity of a completed task for validating the completed task towards the progression of a goal, according to an example embodiment;

FIG. 3A is a block diagram of the order and data in the messages in the system, according to an example embodiment.

FIG. 3B is a block diagram of the blockchain pertaining to task data received for providing verified case information between a plurality of first parties, second parties, and third parties, according to an example embodiment;

FIG. 3C is a block diagram of the blockchain pertaining to task data received for providing verified case information between a plurality of first parties, second parties, and third parties, according to an example embodiment;

FIG. 4 is a diagram illustrating steps for a method of recording a first party user record, a second party user record, and a third party user record, according to an example embodiment.

FIG. 5A is a diagram illustrating steps for a method of determining the veracity of a completed task for validating the completed task towards the progression of a goal, according to an example embodiment.

FIG. 5B is a diagram illustrating steps for a method of determining the veracity of a completed task for validating the completed task towards the progression of a goal, according to an example embodiment.

FIG. 6A is a diagram illustrating steps for a method of grouping a plurality of tokens in a wallet, according to an example embodiment.

FIG. 6B is a diagram illustrating steps for a method of verifying whether aggregated tokens have met predetermined goals, according to an example embodiment.

FIG. 7A is a diagram illustrating a graphical user interface for generating a user record within the system, according to an example embodiment.

FIG. 7B is a diagram illustrating a graphical user interface for entering registration data for a user record, according to an example embodiment.

FIG. 7C is a diagram illustrating a graphical user interface for entering registration data for a user record, according to an example embodiment.

FIG. 7D is a diagram illustrating a graphical user interface for entering registration data for a user record, according to an example embodiment.

FIG. 7E is a diagram illustrating a graphical user interface for entering registration data for a user record, according to an example embodiment.

FIG. 7F is a diagram illustrating a graphical user interface for entering registration data for a user record, according to an example embodiment.

FIG. 7G is a diagram illustrating a graphical user interface for entering registration data for a user record, according to an example embodiment.

FIG. 8A is a diagram illustrating a graphical user interface including a home page, according to an example embodiment.

FIG. 8B is a diagram illustrating a graphical user interface including a second home page, according to an example embodiment.

FIG. 8C is a diagram illustrating a graphical user interface including a notifications page, according to an example embodiment.

FIG. 8D is a diagram illustrating a graphical user interface including a user score, according to an example embodiment.

FIG. 8E is a diagram illustrating a graphical user interface including a graphical representation of a token, according to an example embodiment.

FIG. 8F is a diagram illustrating a graphical user interface including a second graphical representation of a wallet, according to an example embodiment.

FIG. 8G is a diagram illustrating a graphical user interface including a validated task record page, according to an example embodiment.

FIG. 8H is a diagram illustrating a graphical user interface for generating a task record, according to an example embodiment.

FIG. 8I is a diagram illustrating a graphical user interface including a performance message and an incentive message, according to an example embodiment.

FIG. 9A is a diagram illustrating a graphical user interface for a second party, according to an example embodiment.

FIG. 9B is a diagram illustrating a graphical user interface for a second party, according to an example embodiment.

FIG. 9C is a diagram illustrating a graphical user interface for a second party, according to an example embodiment.

FIG. 9D is a diagram illustrating a graphical user interface for a second party, according to an example embodiment.

FIG. 9E is a diagram illustrating a graphical user interface for a second party, according to an example embodiment.

FIG. 9F is a diagram illustrating a graphical user interface for a second party, according to an example embodiment.

FIG. 9G is a diagram illustrating a graphical user interface for a second party, according to an example embodiment.

FIG. 10A is a diagram illustrating a graphical user interface for a third party, according to an example embodiment.

FIG. 10B is a diagram illustrating a graphical user interface for a third party, according to an example embodiment.

FIG. 10C is a diagram illustrating a graphical user interface for a third party, according to an example embodiment.

FIG. 10D is a diagram illustrating a graphical user interface for a third party, according to an example embodiment.

FIG. 10E is a diagram illustrating a graphical user interface for a third party, according to an example embodiment.

FIG. 10F is a diagram illustrating a graphical user interface for a third party, according to an example embodiment.

FIG. 10G is a diagram illustrating a graphical user interface for a third party, according to an example embodiment.

FIG. 11 is a diagram illustrating an SMS message and a reply SMS message, according to an example embodiment.

FIG. 12A is a diagram illustrating a graphical user interface including a list of procedures configured to be displayed on a computing device, according to an example embodiment.

FIG. 12B is a diagram illustrating a graphical user interface including a procedure report configured to be displayed on a computing device, according to an example embodiment.

FIG. 12C is a diagram illustrating a graphical user interface of a wallet and a plurality of tokens configured to be displayed on a computing device, according to an example embodiment.

FIG. 13 is a block diagram of a system including a computing device and other computing devices, according to an exemplary embodiment of present technology.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system and method that accurately validates a completed task. When a first party, or resident, documents a completed task, the task data including task attributes is sent to the attending physician, or second party, of the respective task. The second party must approve the task attributes in order for the first party to send the task data to the server, which hashes and stores the task data along with task approval to the blockchain. The blockchain assigns a non-fungible token (hereinafter “NFT”) to the first party to be stored in a wallet. The NFTs represent proof of approved task data allowing the third party to receive an aggregate number of verified NFTs corresponding to predetermined requirements. The NFT is a unique digital identified that cannot be copied, substituted, or subdivided. The NFT is recorded on a blockchain network to certify ownership and authenticity. The disclosed embodiments also improve upon the prior art's problems by providing a system and method that accurately tracks the progression of a goal such that the third party may analyze performance of the first party and the second party. The disclosed embodiments provide a measurable progression system in which completion of tasks are validated and rewarded. Using progression levels, the system measures the progression statuses to allow the third party to track the performance of the first party and second party such that the latter may be rewarded.

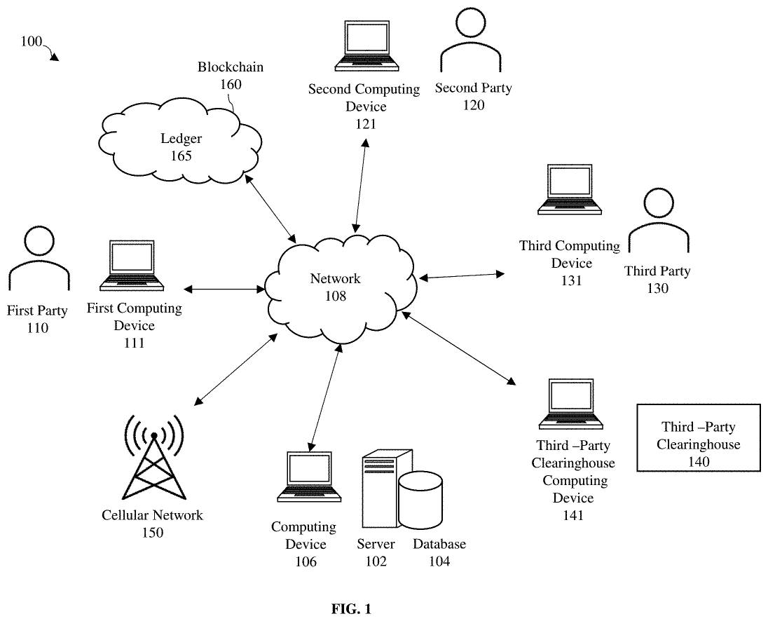

Referring now to the Figures, FIG. 1 is a diagram of an operating environment that supports a system 100 for validating the veracity of a completed task between a plurality of first parties over a communications network in accordance with the principles of the present invention, according to an example embodiment. The most prominent element of FIG. 1 is the server 102 associated with repository or database 104 and further coupled with network 108, which can be a circuit switched network, such as the Public Service Telephone Network (PSTN), or a packet switched network, such as the Internet or the World Wide Web, the global telephone network, a cellular network 150, a mobile communications network, or any combination of the above. In one embodiment, network 108 is a secure network wherein communications between endpoints are encrypted so as to ensure the security of the data being transmitted. Server 102 is a central controller or operator for the functionality that executes on at least a first computing device 111, via various methods.

The networked environment may also include a blockchain system 160 for storing one or more distributed ledgers 165 that records “transactions”, such as adding information including task attributes, device stamp, and an approval from a second party. The transactions are bundled into blocks and every block (except for the first block) refers to or is linked to a prior block in the chain. Computer nodes may maintain the blockchain and cryptographically validate each new block and thus the transactions contained in the corresponding block. A ledger is a record-keeping system that tracks the transactions in accounts. Unlike a centralized ledger, the data in the distributed ledger is immutable because the data is stored on multiple nodes, which are connected independent computers in a network, making it impossible to change the information in the data.

A block chain or blockchain is a distributed database that maintains a list of data records on the ledger. The security of the block chain enhanced by the distributed nature of the block chain. A block chain typically includes several nodes. Each of the nodes may be one or more computers, databases, data stores, machines, operably connect to one another. In some cases, each of the nodes or multiple nodes are maintained by different entities. A block chain typically works without a central repository or single administrator. The data records recorded in the block chain are enforced cryptographically and stored on the nodes of the block chain. A block chain provides numerous advantages over traditional databases. The nodes of a block chain may reach a consensus regarding the validity of a transaction contained on the transaction ledger. The block chain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In the present invention, after the first party completes a task, such information will be recorded on the blockchain.

Users of the block chain create transactions that are passed around to various nodes of the block chain. A “valid” transaction is one that can be validated based on a set of rules that are defined by the particular system implementing the block chain. For example, in the case of present invention, a valid transaction is a first party's task data that has approval from a second party, in some cases, that meets other criteria. In some block chain systems, miners are incentivized to create blocks by a rewards structure that offers a pre-defined per-block reward and/or fees offered within the transactions validated themselves. Thus, when a miner successfully validates a transaction on the block chain, the miner may receive rewards and/or fees as an incentive to continue creating new blocks.

FIG. 1 further includes a computing device, a first computing device, a second computing device, and a third computing device, which each may be mobile computing devices, smart phones, mobile phones, tablet computers, handheld computers, laptops, or the like. A first computing device 111 corresponds to a first party 110. A second computing device 121 corresponds to a second party 120. A third computing device 131 corresponds to a third party 130. Each of the computing devices include a user interface and/or graphical user interface. In certain embodiments, the system may communicate between the first party, the second party, the third party, and the third-party clearing house, over the communications network. The first party performs tasks that must be verified by a second party. The third party oversees the performances of the first party and the second party's verification activity. The server tracks the progression of a goal for the first party such that the third party may analyze the performance of the first party. The goal is to compile a predetermined number of completed tasks that are required by the third party.

In a first embodiment, the first party is a resident health professional, which is a physician who graduated from medical school and is training in a certain specialty through a residency program. The second party is an attending physician in the residency program. The third party is a medical institution or a teaching hospital providing the residency program. In some embodiments, the system may include a fourth party that accredits the resident health professional or the medical institution. The third-party clearinghouse may verify certain information documented by the first party. A completed task is a medical procedure in a residency program performed by the resident. The resident records a completed medical procedure so that the attending physician can validate the medical procedure. The present invention tracks the progression of goals such that each validated task is compiled for the accreditation of the resident health professional. In other embodiments, the first party, the second party, and the third party may be different roles in other modern environments in which tasks must be monitored for progression and performance, such as, but not limited to, corporate offices, sports teams, and car dealerships. The second party manages the first party while the third party oversees the first party and the second party. The first party's input registration data via a graphical user interface on the first computing device 111 to be sent through the communications network via a data packet and stored in the database. The second party's input registration data via a graphical user interface on the second computing device 121 to be sent through the communications network via a data packet and stored in the database. The third parties input registration data via a graphical user interface on the third computing device 131 to be sent through the communications network via a data packet and stored in the database. The registration data may include at least one of a username, email address, physical address, phone numbers, password, biometric information, password, security questions and answers.

FIG. 1 further shows that server 102 includes a database or repository 104, which may be one or more of a relational databases comprising a Structured Query Language (SQL) database stored in a SQL server, a columnar database, a document database and a graph database. Computing devices 111 and 121 may also each include their own database. The repository 104 serves data from a database, which is a repository for data used by server 102 and the mobile devices during the course of operation of the invention. Database 104 may be distributed over one or more nodes or locations that are connected via network 108.

The software is configured to create and store records for the first parties, second parties, and third parties. The database 104 may include a stored record for each of the first parties, second parties, and third parties in the system. The database may be configured to not only store registration data but also store personal identifying information (“PII”) and non-personal identifying information data. PII means information that identifies, relates to, describes, is capable of being associated with, or could reasonably be linked, directly or indirectly, with a particular user. PII data includes, but is not limited to, the following if it identifies, relates to, describes, is capable of being associated with, or could be reasonably linked, directly or indirectly, with a particular user: Identifiers such as a real name, alias, postal address, unique personal identifier, online identifier, Internet Protocol address, email address, account name social security number, driver's license number, passport number, or other similar identifiers; Commercial information, including records of personal property, products or services purchased, obtained, or considered, or other purchasing or consuming histories or tendencies; Biometric Information, such as fingerprint or facial recognition; Internet or other electronic network activity information, including, but not limited to, browsing history, search history, and information regarding a consumer's interaction with an Internet Web site, application, or advertisement; Geolocation data; Audio, electronic, visual, thermal, olfactory, or similar information; Professional or employment related information; Education information, defined as information that is not publicly available personally identifiable information; and, Inferences drawn from any of the information to create a profile about a consumer reflecting the consumer's preferences, characteristics, psychological trends, predispositions, behavior, attitudes, intelligence, abilities, and aptitudes. The PII may further include the telephone number/email address/social network handle of the first party, demographic data for the first party, such as age, sex, income data, race, color, marital status, etc. Non PII data may include information that is anonymous and cannot identify the first party. Non PII data helps protect the first party such that the information may not be used to harm the first party. Non PII data may include device type, browser type, language preference, time zone, etc.

The blockchain 160 stores task data from the first party, which may include attributes about the task including task data, date, time, and geolocation of when and where the task was performed, the date, time and geolocation of when and where the task data was input into the first computing device by the first party (“second device stamp”). The blockchain also stores an approval from the second party of a task.

FIG. 1 shows an embodiment wherein networked computing devices 111 and 121 may interact with server 102 and repository 104 over the network 108. Server 102 includes a software engine that delivers applications, data, program code and other information to networked computing devices 111 and 121. The software engine of server 102 may perform other processes such as audio and/or video streaming or other standards for transferring multimedia data in a stream of packets that are interpreted and rendered by a software application as the packets arrive. It should be noted that although FIG. 1 shows only five networked mobile computing devices, the system of the present invention supports any number of networked mobile computing devices connected via network 108, having at least the computing device 106, the first computing device 111, the second computing device 121, and the third computing device 131.

Server 102 may include a website server that delivers web pages to the first parties 110, the second parties 120, and the third parties 130. Web pages (sometimes referred to herein as, “graphical displays”) may be sent via communications including hypertext markup language (“HTML”), cascading style sheets (“CSS”), and JavaScript files, among others. Additional communications between the various device entities (110, 114, and 118) may include various types of data transfer. The data may be provided in a variety of suitable formats, such as one or more of extensible markup language (“XML”), JavaScript object notation (“JSON”), and other lesser used formats such as YAML (standing for a recursive definition of “YAML Ain′t Markup Language,” and referring to a human-readable data-serialization language). Data objects (e.g., JSON, XML) received by the web browser may be displayed according to accompanying HTML, CSS, and/or JavaScript, depending on the context.

Server 102 also includes program logic comprising computer source code, scripting language code or interpreted language code that is compiled to produce executable file or computer instructions that perform various functions of the present invention. In another embodiment, the program logic may be distributed among more than one of server 102, computing devices 111, 121 and 131, or any combination of the above.

Note that although server 102 is shown as a single and independent entity, in one embodiment of the present invention, the functions of server 102 may be integrated with another entity, such as each of computing devices 111, 121, and 131. Further, server 102 and its functionality, according to a preferred embodiment of the present invention, can be realized in a centralized fashion in one computer system or in a distributed fashion wherein different elements are spread across several interconnected computer systems. While the blockchain is illustrated as a single entity, the blockchain is actually decentralized, meaning that the data in the blockchain is stored into multiple nodes of the network. The decentralized nature of the blockchain allows the data stored within the blockchain to be immutable.

In some embodiments, the operating environment may include a third-party clearinghouse 140, which may be a single computing device, or system connected computing devices. The third-party clearing house 141 computing device may be used as an additional layer or source to verify the authenticity of a first computing device and its associated user. For example, the system may use the third-party computing device to further evaluate attributes not stored on database of the system to validate the first party's identity. For example, the system may use third party computing device as another source to validate the task data documented by the first party. By way of another example, the system may use the third-party computing device as another source to validate the attributes about the task and the second device stamp.

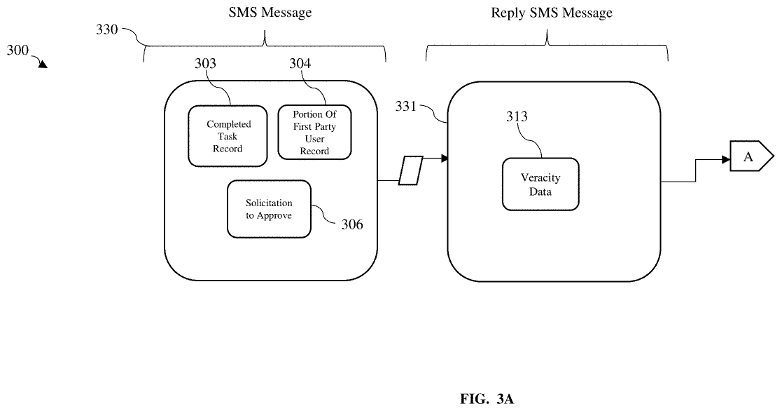

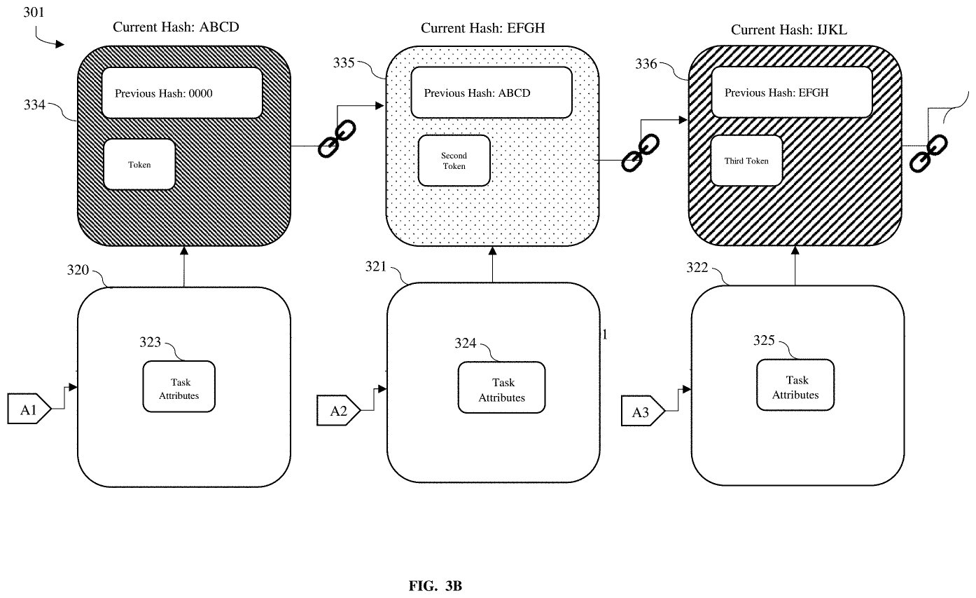

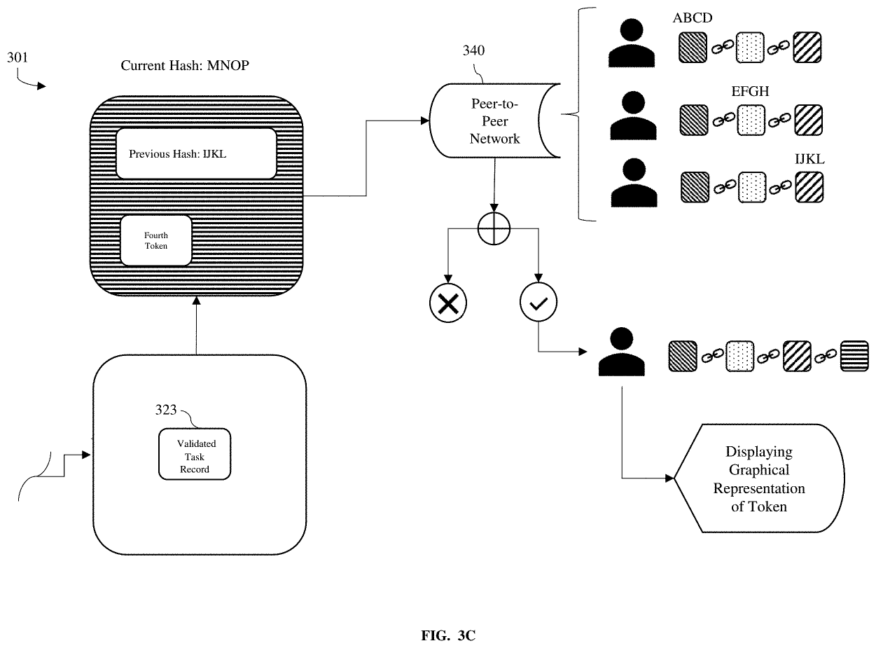

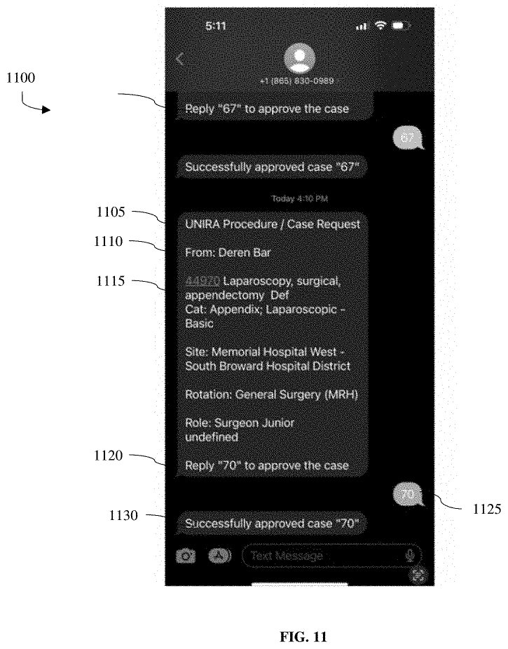

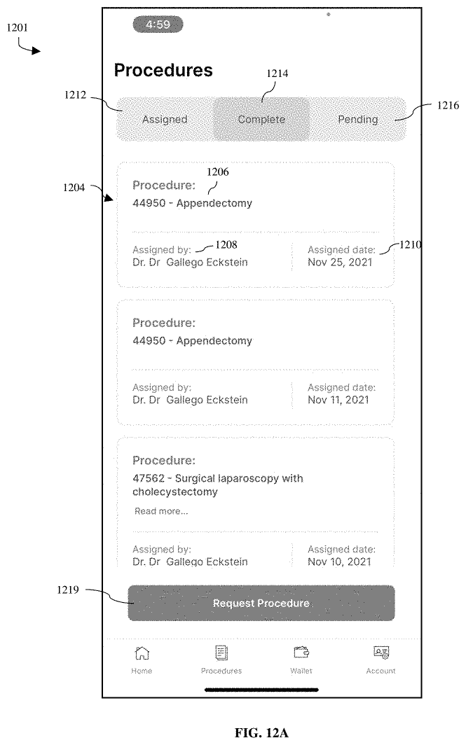

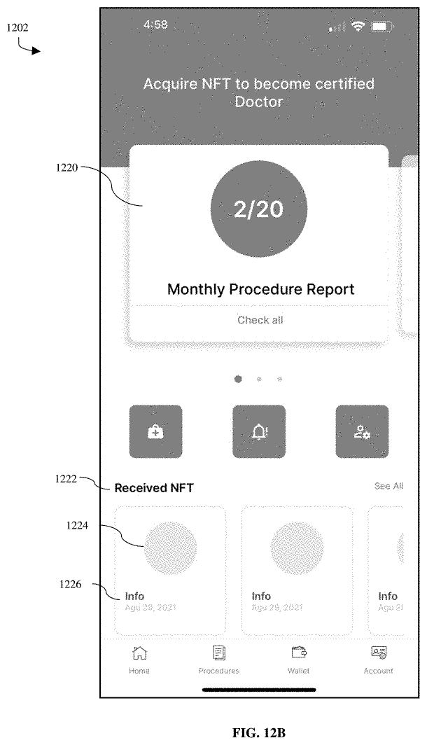

Referring now to FIG. 3A and FIG. 11, a block diagram 300 and an illustration 1100 of the order and data in the SMS messages in the system 100, according to an example embodiment. The SMS messages in the system 100 are received and sent through the cellular network 150. The SMS message 330 is sent to the second computing when the server generates a completed task record. The SMS message includes completed task record 303, a portion of the first party record 304, and a solicitation to approve 306. Shown in FIG. 11, the SMS message 1105 includes the portion of the first party record 1110, the completed task record 1115, and the solicitation to approve 1120. The solicitation to approve may be unique to each completed task. The portion of the first party record may include a name of the first party. The second party sends a reply SMS message 331 to the server to notify the server whether the second party approves or denies the task attributes. The reply SMS message (1125 in FIG. 11) includes veracity data 313 that defines either an approval of the task attributes or a disapproval of the task attributes. If the second party approves the task attributes, the server generates and stores the validated task record to the blockchain to mint a token associated with the validated task record. The server may cause confirmation SMS message 1130 to be sent to the second computing device.

Referring now to FIG. 3B, a block diagram of the blockchain 301 pertaining to task data received for providing verified task data between a plurality of first parties, second parties, and third parties, according to an example embodiment. To validate task data, the server sends the validated task record to the blockchain. Referring to FIG. 3B, after authenticating the task data, an algorithm is applied to the information 301 before storing the information on the ledger in blockchain format. Each of the blocks 334, 335, and 336 illustrated in FIG. 3B illustrate a token awarded to a first party. For example, after the task data associated with the first party is approved, an algorithm is applied to the received validated task records 320, 321, and 322 to produce a validated task record hashed value that is stored on the ledger in blockchain format. Each of the blocks 334, 335, 336 includes validated task record hashed values from each of the validated task records. As illustrated in FIG. 3B, each of the blocks 320, 321, and 322 includes data related to each validated task record from the first party including task attributes 323, 324, and 325, respectively. Referring to FIG. 3C, the most recent block is illustrated being validated by a peer-to-peer blockchain network 340. Once the block is validated and stored on the blockchain network, the NFT is awarded to the first party to be displayed on the computing devices. Transactions on the blockchain network may be verified through a consensus mechanism, such as Proof of Work or Proof of Stake, to prevent fraudulent activity and ensure the accuracy of the ledger. In other embodiments, other consensus mechanisms configured to verify transactions may be used and are within the spirit and scope of the present invention.

The software includes smart contracts that governs the terms of the tokens, or non-fungible tokens (“NFT”), including a royalty payment or the percentage of the sale price that will be transferred to the originator of the NFT upon each subsequent sale. The smart contract is executed automatically upon each sale of the NFT on a secondary market, ensuring that the originator receives the appropriate residual income without the need for manual intervention. In other words, after the completed and verification of a task, the first party is awarded with an NFT. Said first party may sell the awarded NFT to a buyer, such as another first party, a second party, or a third party. Every other sale after this sale will cause the original first party that earned the NFT to earn a percentage of the sale, which is the residual income.

The software is configured for displaying a user interface to at least the first party and the second party for providing a marketplace page. The marketplace page is configured to display a virtual marketplace in which the first party and the second party can buy and sell tokens achieved through the completion of a task. The marketplace is integrated with the blockchain, enabling buyers and sellers to interact with the smart contract governing the NFT and ensuring that the terms of the residual income distribution are enforced. The marketplace provides parties with a platform to showcase their NFTs through graphical representations. The system also includes a user interface that enables creators to issue NFTs and specify the terms of the residual income distribution. The parties can set the percentage of the sale price that will be transferred to them upon each subsequent sale, as well as any other terms or conditions that they wish to include in the smart contract governing the NFT. Parties can also track the sales and revenue generated by their NFTs through the user interface.

The system also includes a payment gateway that enables buyers to purchase NFTs using cryptocurrency or fiat currency. The payment gateway is integrated with the blockchain system and is designed to ensure the secure transfer of funds between buyers and sellers. Payment gateways may include PayPal®, Apple Pay®, BitPay®, Coinbase Commerce®. Other payment gateways may be included and are within the spirit and scope of the present invention.

The system provides several advantages over traditional NFT marketplaces. Firstly, it provides a transparent and fair way for parties to receive ongoing financial benefits from the resale of their NFTs. Secondly, it enables parties to retain control over their digital assets even after they have been sold, as they can specify the terms of the residual income distribution. Finally, it provides a way for buyers to support parties by ensuring that a portion of the sale price goes directly to them.

To ensure compliance with regulatory requirements, the system also includes Know Your Customer (“KYC”) and Anti-Money Laundering (“AML”) procedures. These procedures are designed to verify the identity of buyers and sellers and prevent illicit activities, such as money laundering and terrorism financing. KYC procedures allow financial institutions to confirm the identity of the organizations and individuals they conduct business with, and ensures those entities are acting legally. AML procedures help detect and prevent money-laundering activity.

In operation, the system provides a user-friendly and secure marketplace for the plurality of parties to sell NFTs and receive ongoing residual income from their subsequent sales. Buyers can purchase NFTs with confidence, knowing that the originator of the NFT will receive a portion of the sale price.

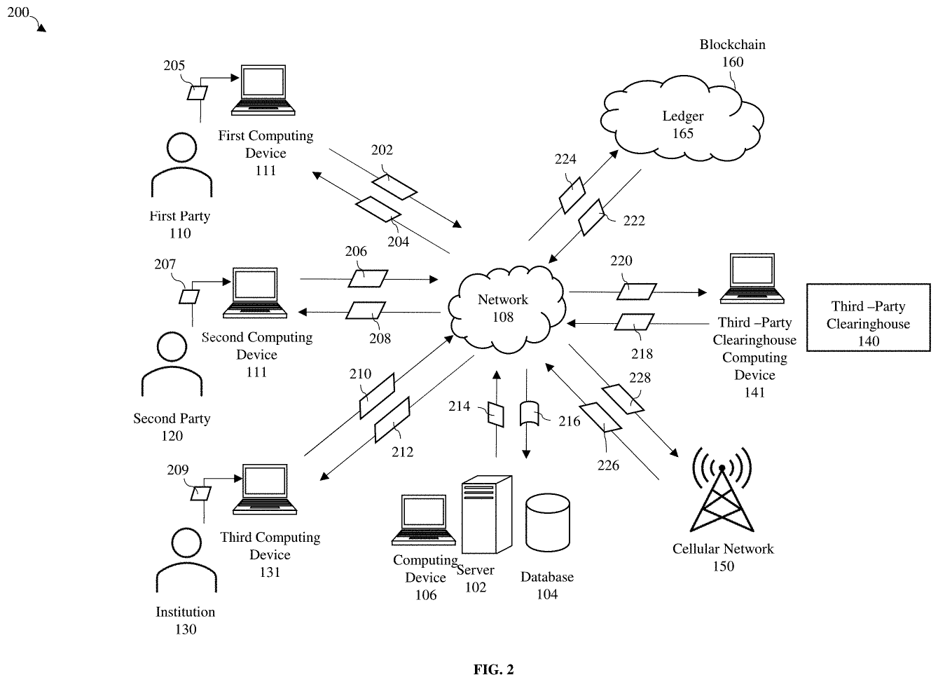

The process for determining the veracity of a completed task for validating the completed task towards the progression of a goal will now be described with reference to FIGS. 2 and 4 through 11. FIGS. 2 and 4 through 11 depict, among other things, data flow and control flow in the process for determining the veracity of a completed task for validating the completed task towards the progression of a goal, according to one embodiment. FIG. 2 is a schematic illustrating communication between the entities in FIG. 1 in relation to validating the completed task towards the progression of a goal, according to an example embodiment. It is understood that in FIG. 2, the data packets 202, 204, 205, 206, 208, 210, 212, 214, 216, 218, 220, 222, 224, 226, and 228 are used to show the transmission of data and may be used at different stages of the process. The first party 110 may use the computing device 111 to communicate with the server 102, which includes the database 104 and blockchain 160 of distributed ledgers 165. The second party 120 may use the second computing device 121, and the third party 130 may use the third computing device 131. The server may provide graphical user interfaces to each of the first party, second party, and third party. Each of the graphical user interfaces may be configured to allow the user to interact with the interface, and/or webpage, such that the interface(s) and display(s) may include a plurality of user interface elements such as input controls, navigation components, informational components, and containers. Such user interface elements may include for example, accordions, bento menu(s), breadcrumb(s), button(s), card(s), carousel(s), check box(es), comment(s), doner menu(s), dropdown(s), feed(s), form(s), hamburger menu(s), icon(s), input field(s), kebab menu(s), loader(s), meatball menu(s), modal(s), notification(s), pagination(s), picker(s), progress bar(s), radio button(s), search field(s), sidebar(s), slide control(s), stepper(s), tag(s), tab bar(s), tool tip(s), and toggle(s). Each of these user interface elements may be used in certain embodiments to enable each of the users to interact with the system, provide data to and from the server across the communications network and implement the methods as discussed in FIGS. 4 through 6B. Other user interface elements configured to provide a display to the user to interact with the system in accordance with the methods described herein may be used and are within the spirit and scope of the disclosure. The user may interact with the graphical user interfaces using gestures to trigger certain elements on the graphical user interfaces. A gesture may include computer gestures such as a tap, via a touch sensitive interface display, a click, on or near one of the second user graphical indicators.

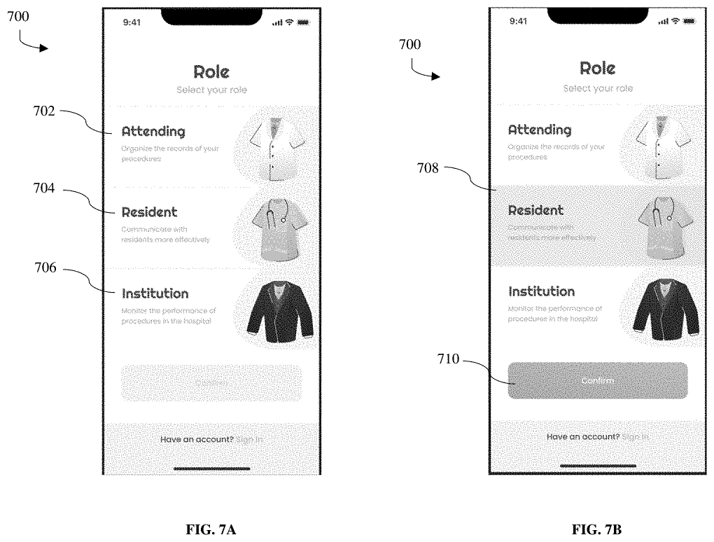

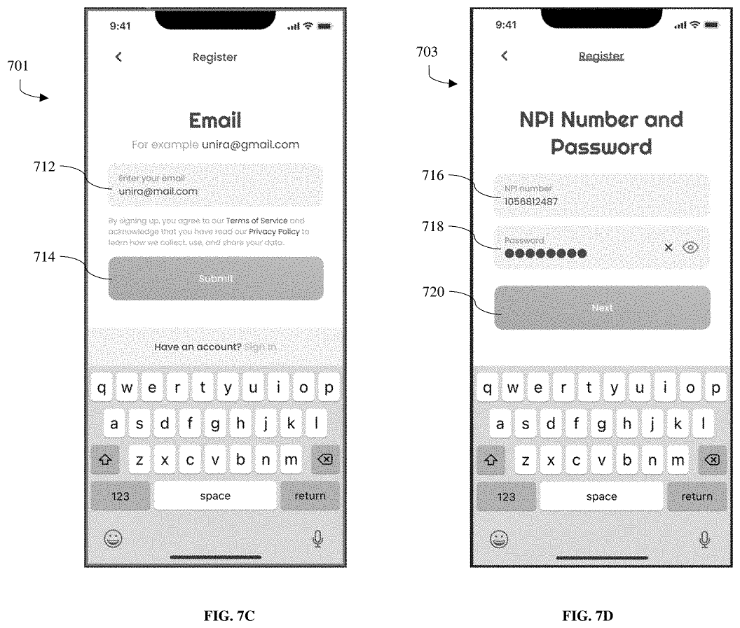

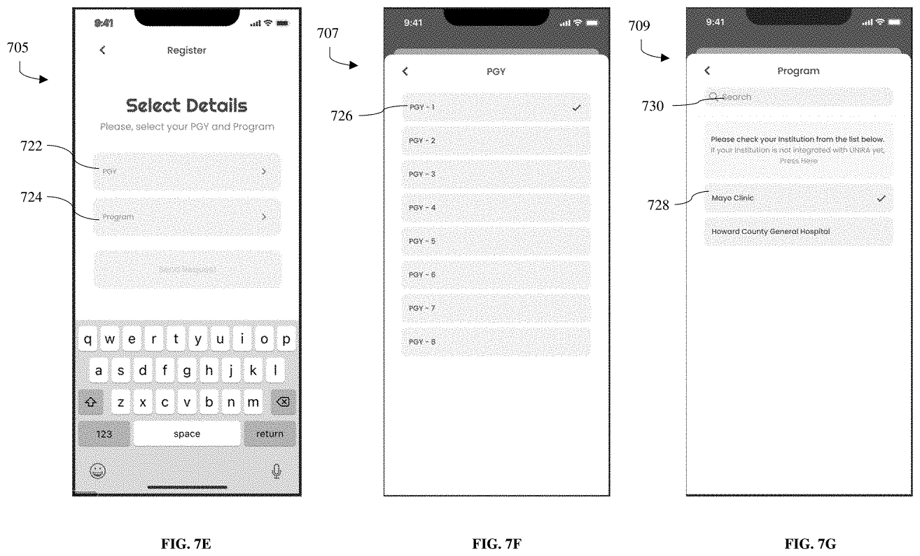

Referring now to FIG. 4, a diagram illustrating steps for a method of storing a first party user record, a second party user record, and a third party user record is shown, according to an example embodiment. The server may send data packet 214, including data configured to display graphical user interfaces, including but not limited to, those in FIGS. 7A through 7G, to be received as data packets 204, 208, and 212 by each of the first computing device, second computing device, and third computing device, respectively. The graphical user interfaces are configured to allow the parties associated with said computing devices to enter registration data corresponding to each party. Prior to step 405, the first party interacts with the graphical user interfaces to input first party registration data as data packet 205 on the first computing device associated with the first party. The first party registration data includes a first unique identifier associated with the first party. In step 405, the computing device 106 via a transceiver receives first party registration data, for generating a first party user record, from the first computing device 111 associated with the first party 110. The computing device 106 associated with the server 102 generates a first party user record in an attached database 104. In step 410, the computing device 106 stores the first party registration data associated with the first party into the first party user record in the connected database 104. Prior to step 415, the second party interacts with the graphical user interfaces to input second party registration data as data packet 207 on the second computing device associated with the second party. In step 415, the computing device 106 via the transceiver receives second party registration data, for generating a second party user record, from the second computing device 121 associated with the second party 120. The second party registration data includes a second unique identifier associated with the second party. The second party inputs the second party registration data on the second computing device associated with the second party. The computing device 106 generates a second party user record in the connected database 104. In step 420, the server stores the second party registration data associated with the second party into the second party user record in the connected database. Prior to step 425, the third party interacts with the graphical user interfaces to input third party registration data as data packet 209 on the third computing device associated with the third party. In step 425, the computing device 106 via the transceiver receives third party registration data, for generating a third party user record, from the third computing device 131 associated with the third party. The third party registration data includes unique task requirements associated with the third party. The unique task requirements define the goals required by the third party for the first party to receive accreditation. The third party inputs third party registration data on the third computing device associated with the third party. The computing device 106 generates a third party user record in a connected database 104. In step 430, the server stores the third party registration data associated with the third party into the third party user record in the connected database.

The first unique identifier and second unique identifier may be a piece of information that uniquely identifies an entity or object. In some embodiments, the unique identifiers may be a numeric, letter, or alphanumeric sequence assigned to an object or entity to distinguish it from other similar objects or entities. In other embodiments, other forms of unique identifiers may be used and are within the spirit and scope of the present invention.

It is understood that this method is a continuous cycle and that each step of method 400 may operate concurrently with another step of method 400 to create and store records for first parties, second parties, and third parties. In other embodiments, the method may further include additional steps to create and store records consistent with the systems disclosed herein.

Referring now to FIGS. 7A through 7G, diagrams illustrating graphical user interfaces configured for inputting registration data is shown, according to an example embodiment. The server may provide specific graphical user interfaces for each of the first party, second party, and third party allowing the first party 110, second party 120, and third party 130 to input corresponding registration data. A role selection interface 700 shown in FIG. 7A is configured to be displayed on each of the first party computing device 111, second party computing device 121, and third party computing device 131. In the role selection interface, a user in the system may select one of at least three roles, including the first party 704, the second party 702, and the third party 706. In the first embodiment, the first party is a resident, the second party is the attending, and the third party is a medical institution. There may be additional roles in the system such as an accrediting institution. Shown in FIG. 7B, the user has chosen the resident, so the user is a first party. The role selection interface will highlight or shade 708 in the selected role to indicate to the user which role has been selected. The user may confirm by interacting with the confirm button 710. Shown in FIG. 7C, the graphical user interface 701 includes an email input box 712 that prompts a user to enter their email address. The graphical user interface 701 includes a submit button 714 that allows the user to confirm their email input, which leads to the graphical user interface 703 shown in FIG. 7D. The graphical user interface 703 includes a National Provider Identifier (“NPI”) number input box 716 and a password input box 718. The NPI is a unique identification number for covered health care providers. The graphical user interface 703 also includes a submit button 720 that allows the user to confirm their input. Shown in FIG. 7D, the graphical user interface 705 is configured to be displayed on a first party computing device. The graphical user interface 705 includes graphical user interface elements that allow the first party to input a post graduate year (“PGY”) 722 and a program 724. When the first party interacts with the PGY element, graphical user interface 707 (FIG. 7F) is displayed and is configured to allow the first party to select their corresponding PGY 726 from a list of PGY options. When the first party interacts with the program element, graphical user interface 709 (FIG. 7G) is displayed and is configured to allow the first party to select their corresponding program 728 from a list of program options. The first party may also use the search bar 730 to find a program from the list of PGY option. Graphical user interface 705 may also be configured to be displayed on the second party computing device and the third party computing device. For example, for the second party, graphical user interface elements 722 and 724 may prompt the second party to select an institution and a specialty, respectively. The server may provide additional prompts within graphical user interfaces 700, 701, 703, 705, 707, and 709 for other registration such that the devices 111, 121, and 131 may provide other registration data to be included in the corresponding party record.

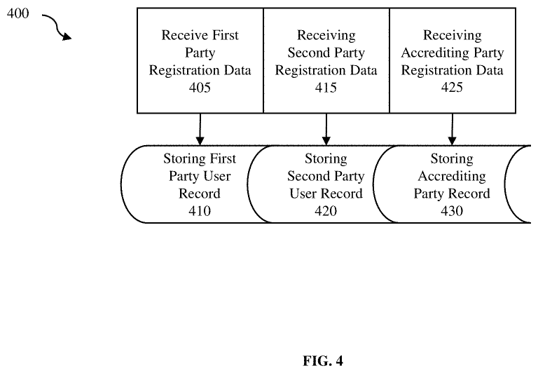

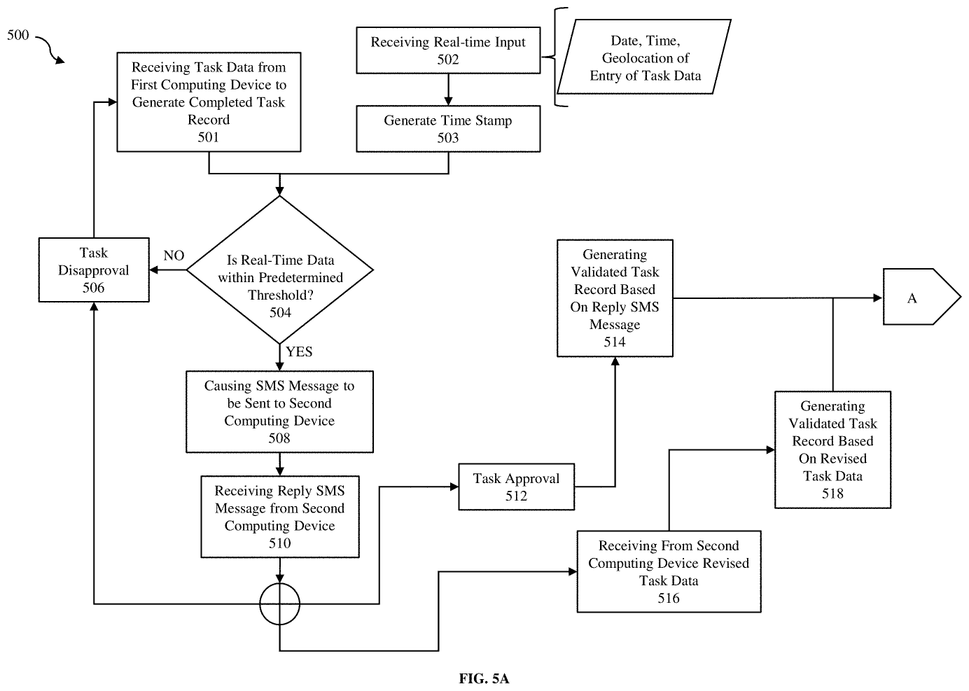

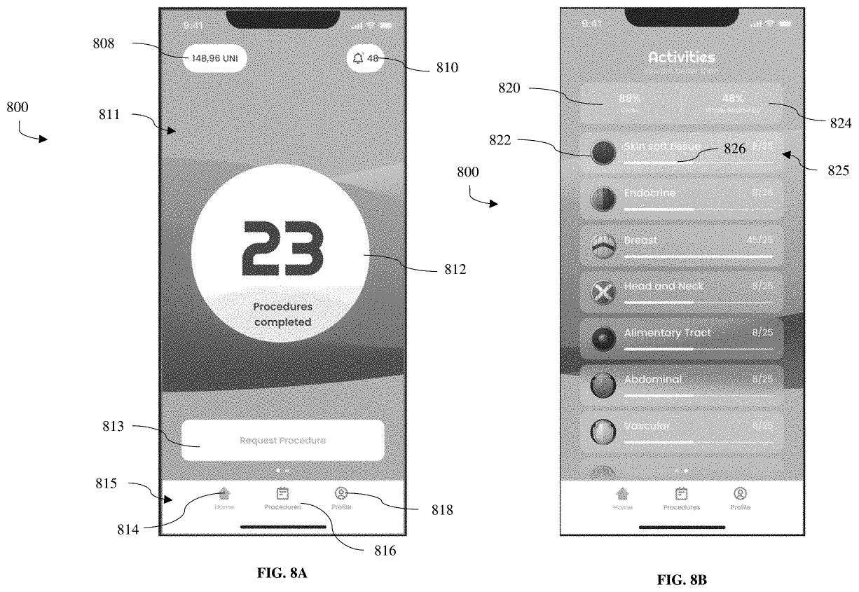

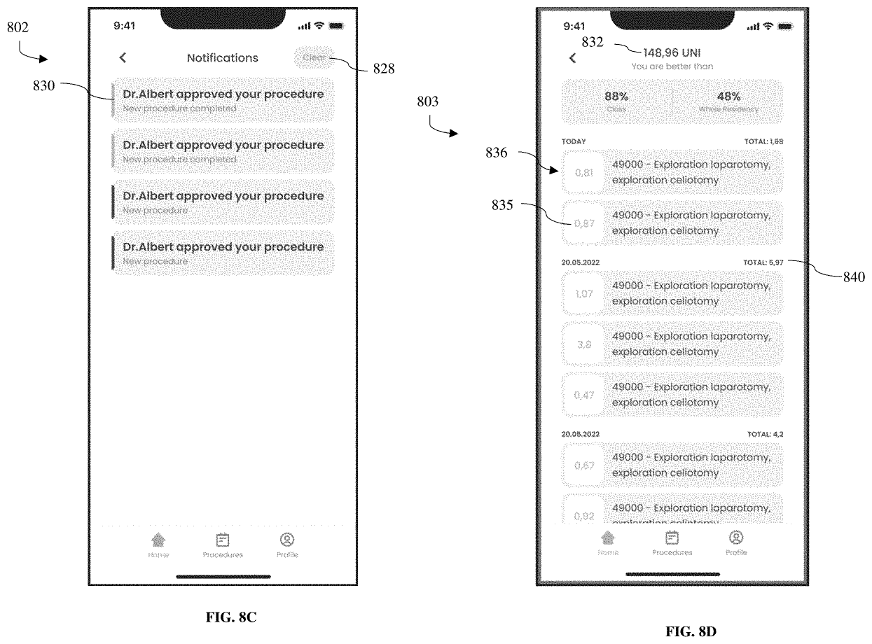

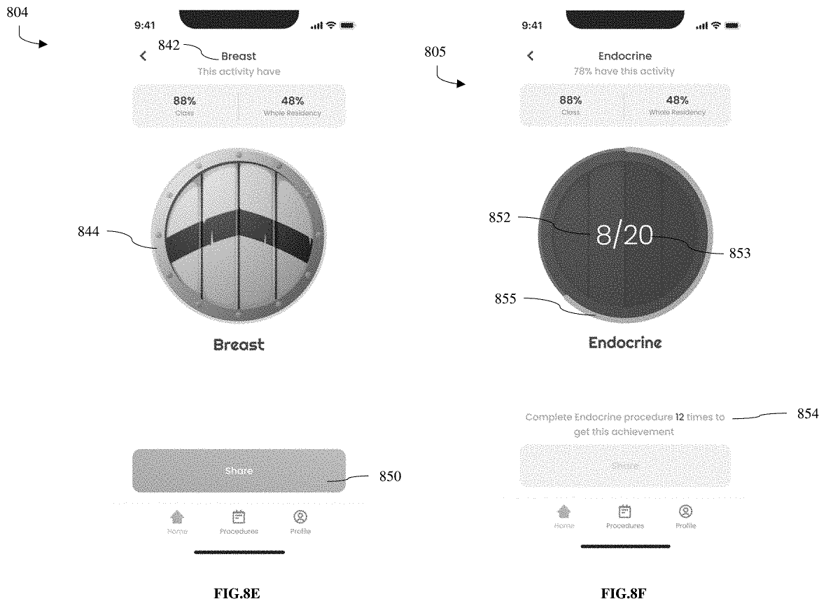

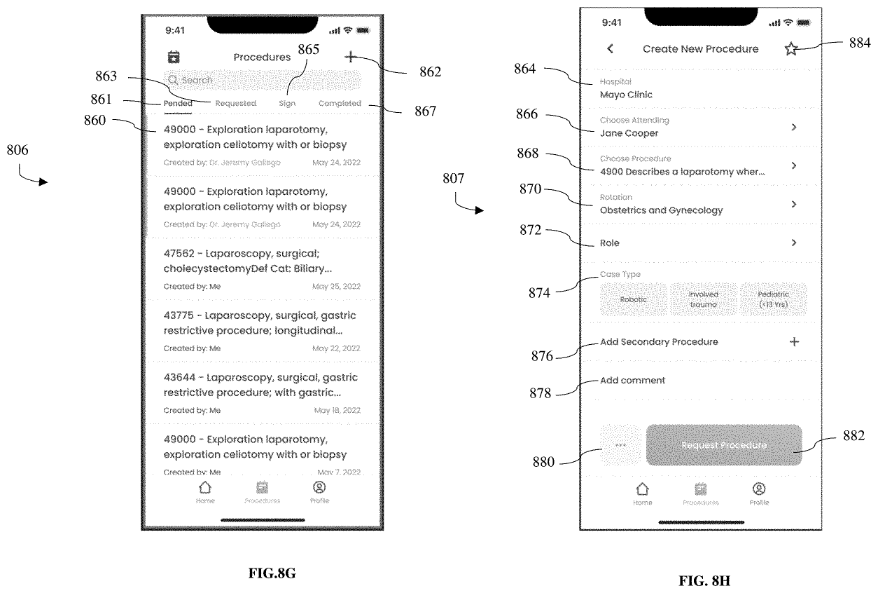

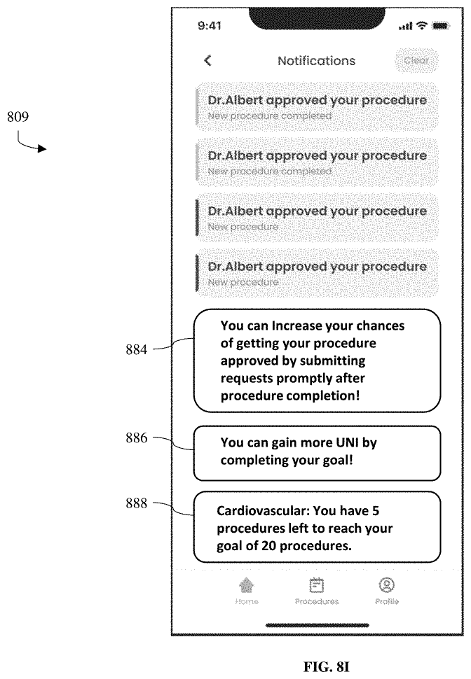

FIG. 5A is a diagram illustrating steps for a method 500 of validating a complete task, according to an example embodiment. The server may provide a new task interface 801 (shown in FIG. 8B) allowing the first party 110 to input task attributes via data packet 205 to be included in the task data. The new task interface may also be configured to be displayed on the second computing device and the third computing device. In some cases, instead of the first party entering task data to the first computing device, the second party may generate a task record to request a first party to complete the task defined in the task record. The task data includes a plurality of attributes of the completed task. The plurality of attributes may include the type of procedure performed, hospital, rotation, user role, patient name, attending physician name, secondary procedure, and comments regarding the completed task. However, other information about the task may be included in the task data and is within the spirit and scope of the present invention. In step 501, once the first party enters the task data via data packet 205 into the first computing device 111, the first computing device sends data packet 202 including task data.

The computing device 106, prior to determining the veracity of the completed task, receives the data packet 216 including task data through the transceiver to generate a completed task record. The computing device 106 receives the task data at the direction of the first party because the first party enters task data into the first computing device, which sends the task data to the computing device 106. In step 502, concurrently to receiving task data, the computing device 106 receives real-time input data automatically generated from the first computing device. The first computing device generates and sends the real-time input data at the same time at which the first party inputs task data into the first computing device. Then, in step 503, the computing device 106 generates a time stamp associated with the entry of the task data using the real-time data. The real-time input data includes the date, time, and geolocation of the entry of the task data on the first computing device. In other embodiments, the real-time input data may include other information configured to be tested as evidence. In step 504, the processor of the computing device determines if the real-time data is within the predetermined threshold. The predetermined threshold includes a predetermined period of time or a predetermined maximum distance. For example, the computing device 106 determines if the time stamp is within a predetermined period of time after the completed task was performed and if the geolocation is within the predetermined maximum distance to where the completed task was performed. The real-time input data provides evidence to the system that the task may have been completed in the right time and place as defined in the task data. The predetermined period of time is based on the task data. If the predetermined threshold is not satisfied, then the task data is denied in step 506. The computing device may send a denial message via data packet 204 to the first computing device 111. The denial message may notify the first party that the first party must re-input the task data in step 502.

If the predetermined threshold is satisfied, then the computing device 106 causes an SMS message to be sent to the second computing device of the second party to determine the veracity of the completed task in step 508. The computing device 106 sends data packet 214, including the SMS message, to be received by the second computing device as data packet 208. The SMS message includes at least a portion of the first party user record, the completed task record, and a solicitation to approve the completed task record. The second party enters a response onto the seconding computing device and into a reply SMS message. The second computing device sends the reply SMS message in data packet 206. In step 510, the computing device 106 receives via the transceiver data packet 206 including the reply SMS message from the second computing device. The reply SMS message includes veracity data the defines an approval or a disapproval of the completed task record. The computing device 106 may also send the reply SMS message to the first computing device of the first party. If the computing device 106 determines that the veracity data only defines a disapproval, then the task is denied in step 506. The computing device may send the denial message via data packet 204 to the first computing device 111. The denial message may notify the first party that the first party must re-input the task data in step 501. If the computing device 106 determines that the veracity data only defines an approval, then the task is approved in step 512. In step 514, the computing device 106 generating a validated task record based on the reply SMS message.

Alternative, if the second party disapproves the completed task record, the second party may interact with the graphical user interfaces provided by the server 102 to generate revised task data for the completed task record. The revised task data comprising at least one change to at least one attribute of the plurality of attributes. The second computing device sends the revised task data via data packet 206 over the communications network 108. In step 516, the computing device 106 receives data packet 216 including the revised task data from the second computing device. In step 518, the computing device 106 generates the validated task record based on the revised task data.

Referring to FIG. 5B, a diagram illustrating steps for a method 500 of validating a complete task is shown, according to an example embodiment. In step 520, the computing device 106 sends data packet 214 including the validated task record to be stored as data packet 224 into the blockchain 160. In step 522, the computing device 106 mints a token associated with the validated task. In step 524, the computing device 106 sends the token via data packet 214 to be received by the first computing device as data packet 204. The token is a form of receipt that is associated with the approved task. The token is a non-fungible token. The token is assigned to a public key that is assigned to the first party that earned the token. Then, in step 524, the computing device 106 sends via the transceiver data packet 214, which includes the token associated with the approved task. Data packet 214 is sent to the first computing device as data packet 204, the second computing device as data packet 208, and the third computing device as data packet 212.

In step 526, the computing device 106 generates a numerical score for the validated task record based on a plurality of predetermined scoring metrics. In step 528, after generating a numerical score for the validated task record, the computing device 106 calculates a user score based on the numerical score of the validated task record. The user score is a performance metric that may indicate the first party's progression. A user score is based on the number of validate tasks, the number of achieved goals, and number of validation rejections they receive. For example, the first party may receive a user score when they achieve a goal. In another example, the first party may receive a reduced numerical score if they do not enter task data within the predetermined threshold defined in step 504. The user score may be used to redeem rewards provided by the third party to also provide incentives. In step 530, the computing device 106 generates a progress interface for displaying a progression status indicator on the first computing device. The computing device 106 generates a progression level towards the goal based on comparing the validated task record to the unique task requirements of the third party record. The progression level is another performance metric that allows the first party to analyze the number of tasks or type of tasks that need to be completed and validated. The progression level may be measured by the number of completed tasks associated with the first party.

It is understood this method 500 is a continuous cycle and that each step of method 500 may operate concurrently with another step of method 500 to validate completed tasks. In other embodiments, the method may further include additional steps to validate completed tasks consistent with the systems disclosed herein.

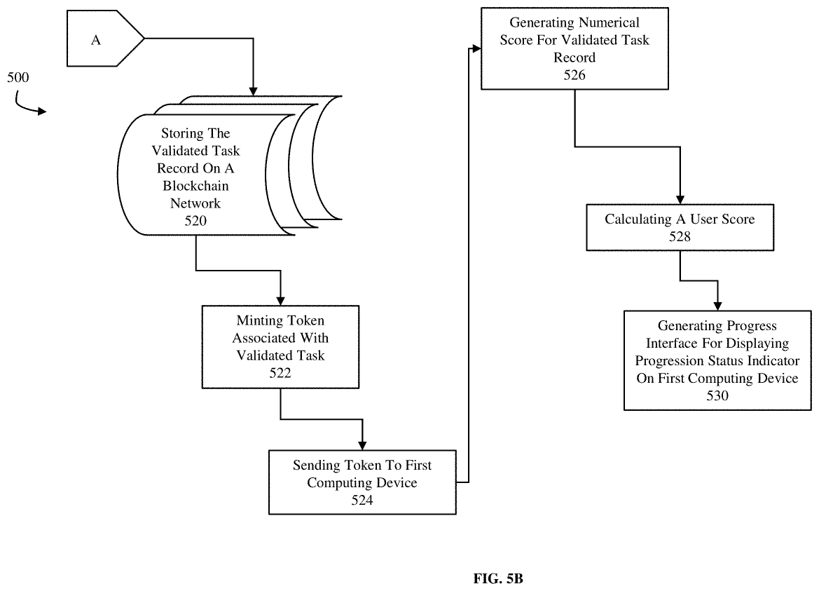

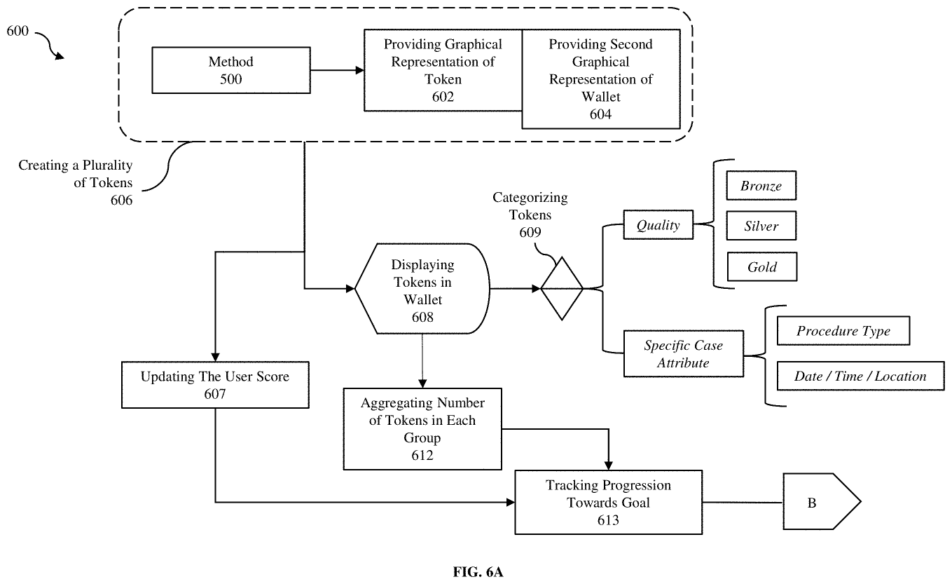

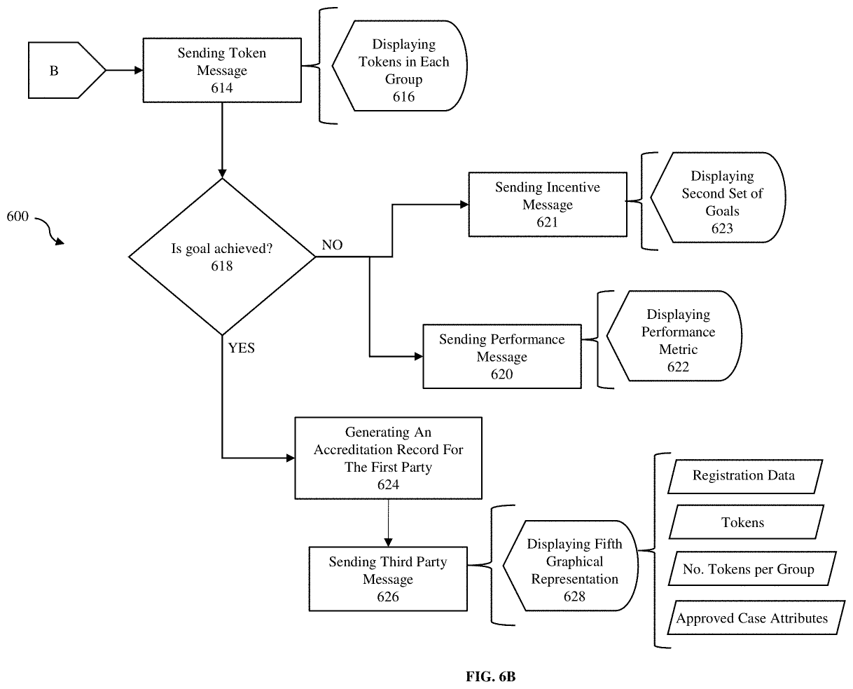

Referring now to FIGS. 6A and 6B, a diagram illustrating steps for a method 600 of grouping and aggregating tokens, according to an example embodiment. FIG. 6A is a diagram illustrating steps for a method 600 of grouping a plurality of tokens in a wallet, according to an example embodiment. FIG. 6B is a diagram illustrating steps for a method of verifying whether aggregated tokens have met predetermined goals, according to an example embodiment. Shown in FIG. 6A, in step 602, the computing device generating a graphical representation of the token for the validated task record based on at least one attribute of the plurality of attributes. The graphical representation of the token may be illustrated as a unique icon that describes the completed task. For example, the graphical representation of the token may be an organ corresponding to a type of medical procedure completed by a resident. In step 604, the computing device generating a second graphical representation of a wallet to be sent to the first computing device for displaying the graphical representation of the token. Each user is a assigned a wallet that displays a plurality of tokens. In step 606, method 500 and steps 602, 604 are repeated to create the plurality of tokens for a plurality of validated tasks associated to the first party. In step 607, the computing device 106 updates the user score based on calculating an updated user score. The updated user score is based on processing each validated task record of the plurality of validated task records. In step 608, each token of the plurality of tokens is displayed in the wallet on at least one of the first computing device, the second computing device, and the third computing device. In step 609, the computing devices 111, 121, and 131 categorize the plurality of tokens, based on a plurality of validated attributes of a plurality of validated tasks. The tokens are categorized into a predetermined group of a plurality of predetermined groups that each correspond to a specific attribute of the plurality of attributes. Each of the predetermined groups corresponds to a specific task attribute.

In step 612, the computing device 106 aggregates the number of tokens in each of the predetermined groups. In step 613, the computing device 106 tracks progression towards the goal by continuously updating the progression status indicator on the first computing device. Continuously updating the progression status indicator includes generating an updated progression level after processing each validated task record of the plurality of validated task records and generating an updated progress interface to be displayed on the first computing device.

Referring to FIG. 6B, in step 614, the computing device 106 sends via the transceiver data packet 214, which include a token message, to at least one of the first computing device, the second computing device, and the third computing device. The token messages include a third graphical representation of the tokens within each predetermined group. In step 616, the computing devices 111, 121, and 131 displays the third graphical representation of the tokens in each group. In step 618, using the processor, the computing device determines if a total number of first tokens within each predetermined group satisfies a predetermined goal for each respective specified task attribute. If the predetermined goal is not met, the computing device 106 sends, via data packet 214, at least one of a performance message to the computing device of the respective party in step 620 or an incentive message to the computing device of the respective party in step 621. The performance message includes performance data configured to display a performance metric 622 for the first party. The incentive message includes incentive data configured to display a second set of goals 623, or incentives, to complete to receive an incentive. The second set of goals help motivate the first party to complete tasks or generate completed tasks timelier. This helps improve the validation rates of the completed task records. For example, referring to FIG. 8I, graphical user interface 809 is configured to be displayed on a first computing device and displays incentive messages 884, 886 and a performance message 888. The performance message displays a performance metric notifies the first party how many tasks must be completed and validated to reach the goal required by the third party. The incentive message 884 indicates that the first party should enter their completed task records promptly or in proximity to the completion of their tasks. The incentive message 886 notifies the first party that they can gain more user score, or a bonus user score, by reaching the goals required by the third party. These incentive messages include a second set of goals that help motivate the first party to achieve their goals such that they can gain accreditation from the third party.

If the predetermined goal is met, in step 624, the computing device 106 generates an accreditation record for the first party when the goal is achieved. Achieving the goal includes at least one of the user score of a first party reaches a predetermined maximum user score, all unique task requirements of the third user record have been satisfied by the plurality of validated task records of the first party, and the progression level reaches a predetermined maximum progression level. The accreditation record may be generated by the third party to validate the first party's goal achievement. In step 626, the computing device 106 sends data packet 214 including a third party message to a third computing device 131. The third party message comprises a fifth graphical representation that includes the registration data from the first computing device associated with the first party and the total number of first tokens within each predetermined group. In step 628, the third party computing device 131 displays the fifth graphical representation.

It is understood this method is a continuous cycle and that each step of method 600 may operate concurrently with another step of method 600 to group and aggregate tokens. In other embodiments, the method may further include additional steps to group and aggregate tokens consistent with the systems disclosed herein.

Referring now to FIGS. 8A through 8I, illustrations of a graphical user interface for each of a plurality of pages configured to be displayed on the first computing device is shown, according to an example embodiment. The graphical user interfaces shown in FIGS. 8A through 8F may also be configured to be displayed on the second computing device and the third computing device and may include respective graphical elements configured for a second party or a third party. Referring to in FIG. 8A, graphical user interface 800 illustrates a home page including at least two slides. A first slide 811 of the home page includes a user score 808, a notifications icon 810, and a number of procedures completed 812. The first slide also includes a procedure request button 813 configured to display graphical user interface 807, shown in FIG. 8H, to request a procedure. Graphical user interface 807 is configured to allow the user to enter task attributes related to a completed procedure and will be discussed below. The first party may swipe or slide the first slide to the left to display a second slide of the home page, shown in FIG. 8B. The second slide includes the progression status indicators 825. The progression status indicators include a progression status icon 822 and a progression status bar 826. The progression status bar increases in length until the goal in the corresponding category is reached. The second slide may also display the class percentage 820 and residency percentage 824 that the user is better than. The graphical user interface 800 also includes a page bar 815 including a home page icon 814, a procedures page icon 816, and a profile page icon 818.

The user may interact with the notifications icon 810 in the first slide such that the graphical user interface 802 shown in FIG. 8C is displayed to show a list of notifications 830. Each notification may include a description of the approval of completed tasks. Graphical user interface 802 may include a clear button 828 to remove notifications from the list. The user may interact with the user score 808 in the first slide such that the graphical user interface 803 in FIG. 8D is displayed to show a list of validated completed tasks 836 that include a numerical score 835. The graphical user interface 803 may include the user score 832 that corresponds to the user score 808 in the first slide. The graphical user interface 803 may include a total score 840 per day to allow the user to track score earned each day. The graphical user interface 803 helps the user track the history of score earned by each complete task.

FIG. 8E illustrates a graphical user interface 804 displayed when the user interacts with the progression status indicators (825 in FIG. 8A) that include an achieved goal. Graphical user interface 804 displays the progression of a goal of an activity 842. When the first party achieves a goal by reaching the predetermined maximum progression level, graphical user interface 804 displays a fully colored emblem, or fully colored badge, 844 corresponding to certain task. The badge may be a graphical representation of a token associated with a validated task record. The badge is fully colored when a goal is reached by the first party. Additionally, when the first party achieves the goal, the first party may interact with the share button 850 to share their progression online. FIG. 8F illustrates a graphical user interface 805 displays when the user interacts with the progression status indicators (825 in FIG. 8A) that include an unachieved goal. The graphical user interface 805 displays a faded emblem, or faded badge, that includes the progression level 852 out of the predetermined maximum progression level 853 of the corresponding goal. The progression status bar 855 is curved to progress around the faded badge. Once the progression level reaches the predetermined maximum progression level, the progression status bar 855 fully surrounds the faded badge. Then, the progression levels are removed, and the badge becomes unfaded, as depicted in FIG. 8E. The graphical user interface 805 includes the number of remaining progression levels 854 required to achieve the corresponding goal. The progression levels allows the performance of the first party to be measurable based on the accumulated number of validated tasks.

Referring to FIG. 8G, a graphical user interface 806 configured to display a task page that includes a list of tasks 860 is illustrated, according to an example embodiment. The tasks are categorized into different tabs including pending tasks 861, requested tasks 863, signed tasks 865, and completed tasks 867. The user may interact with each tab to display a list of corresponding tasks. Each task in the list of tasks may include a summary of task attributes. The graphical user interface 806 further includes a plus sign icon 862 that, when interacted with, causes the computing device to display the graphical user interface 807 illustrated in FIG. 8H. Referring to FIG. 8H, the graphical user interface 807 is configured to allow the user to create a completed task record by entering task data. The graphical user interface 807 includes inputs for a plurality of task attributes. In graphical user interface 807, the plurality of task attributes includes a hospital name 864, an attending physician name 866, a procedure name 868, a rotation 870, a role 872, a type of case 874, an optional secondary procedure 876, and comments 878. Other task attributes may be used and are within the spirit and scope of the present disclosure. The graphical user interface 807 also includes an options button 880 and a request procedure button 882. Interacting with the options button will cause the graphical user interface 807 to display a pop up menu including the options to save the task to the pending tabs or to delete the task. Interacting the request procedure button 882 will send a data packet including the task record to the computing device 106.

In other embodiments, while graphical user interfaces 800, 801, 802, 803, 804, 805, 806, 807, and 809 include the page bar 815 with icons, said graphical user interfaces may also include a marketplace page icon in the page bar that, when interacted with, is configured to display a marketplace page. The marketplace page is configured to display the virtual marketplace in which the parties can buy and sell tokens.

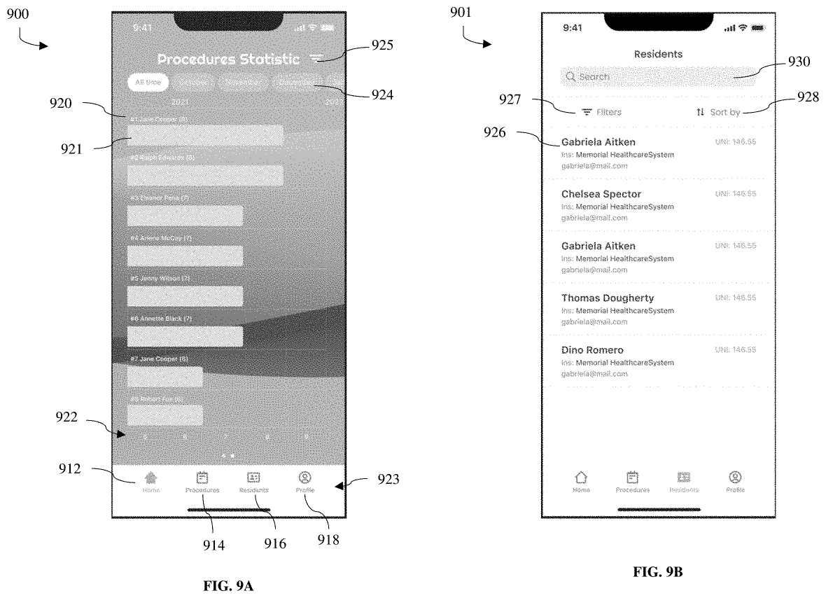

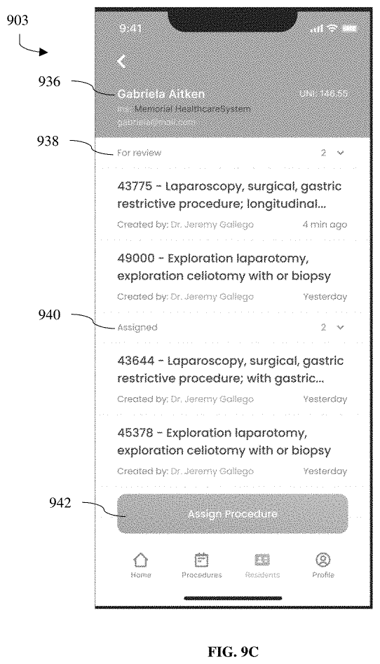

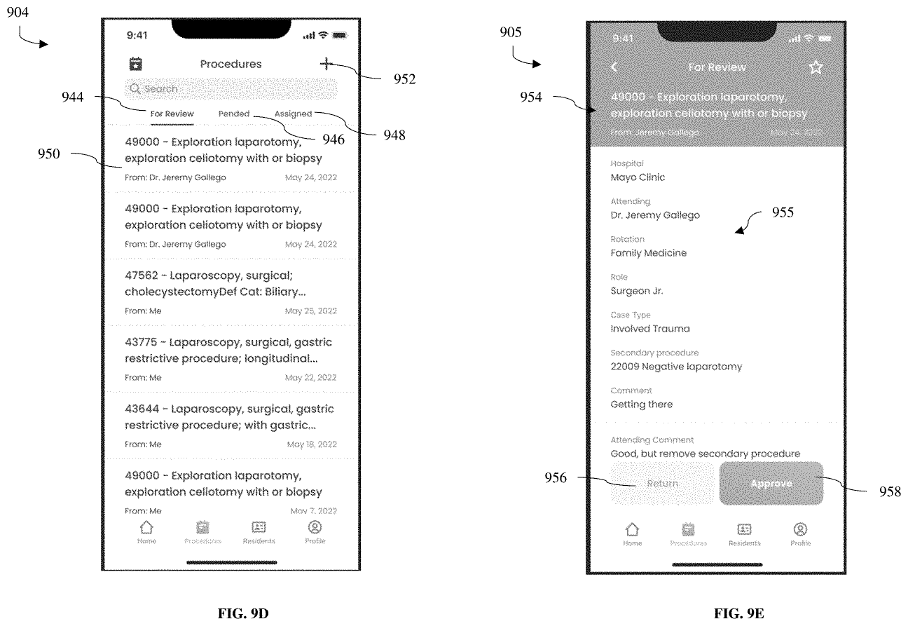

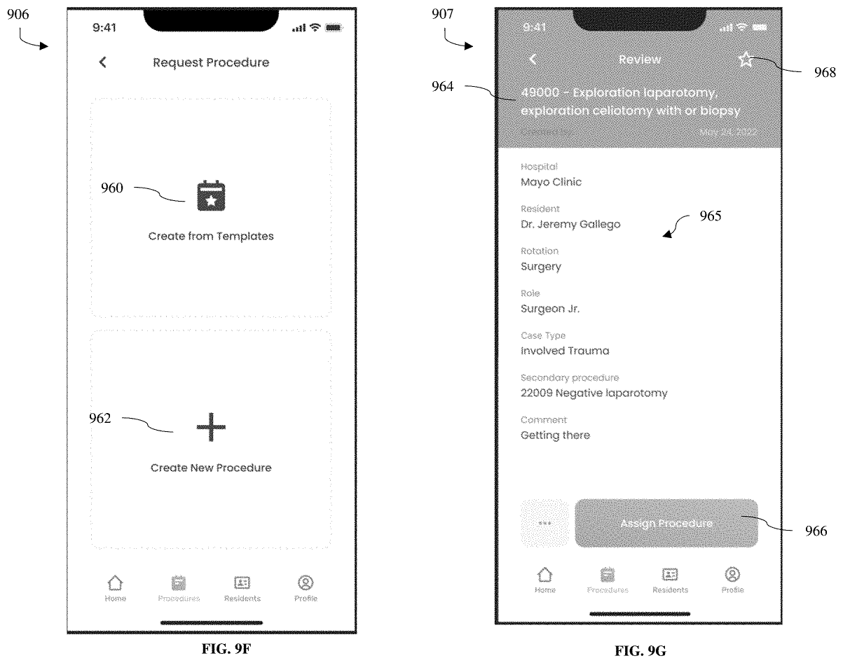

Referring now to FIGS. 9A through 9G, illustrations of a graphical user interface for each of a plurality of pages configured to be displayed on the second computing device is shown, according to an example embodiment. FIG. 9A illustrates graphical user interface 900 displaying a home page that includes task statistics for a plurality of first parties supervised by a second party. The home page includes a bar graph that displays the number of validated tasks for each of the first parties under the second party's supervision. The x-axis 922 of the bar graph is the number of validated tasks. A bar 921 is positioned proximate to each of the first party names 920 and is configured to extend to a corresponding number of validated tasks on the x-axis 922. The bar graph can be filtered by a period of time 924 or by interacting with the filter icon 925. The graphical user interface 900 includes a page bar 923 with a home page icon 912, task page icon 914, first party page icon 916, and a profile page icon 918. The second party can interact with any of the page icons to open a corresponding page. The second party can interact with the first party page icon 916 to display the graphical user interface 901 of the first party page that displays a list of first party entries under the second party's supervision. For each first party entry 926 in the list of first party entries, the graphical user interface displays a summary of the first party record associated with the first party entry, such as a name of the first party, an affiliated third party, an email of the first party, and a user score of the first party. The second party can filter the list of first party entries by interacting the filter icon 927, sort the list of first party entries by interacting with the sort by icon 928, and search through the list of first party entries by interacting with the search bar 930.

Interacting with a first party entry will select the first party entry to display the graphical user interface 903 that includes the name, the user score, the affiliated third party, and an email of the selected first party 936. Graphical user interface 903 also includes a list of task entries for review 938 and a list of assigned task entries 940. The second party may also interact with the assigned task button 942 to create a new task to assign to a first party.

Illustrated in FIG. 9D, graphical user interface 904 displays a task page that includes a list of task entries 950. The task page also includes a review tab 944, pending tab 946, and assigned tab 948. The review tab lists task entries that must be reviewed, and the pending tab lists task entries that must be assigned to a first party. The assigned tab lists task entries that are waiting to be completed by a first party. The second party can select a task entry by interacting with the task entry. Selecting a task entry under the review tab 944 will display graphical user interface 905 shown in FIG. 9E. Graphical user interface 905 displays the task record 954 of the selected task entry and its associated task data 955 along with a return button 956 and an approve button 958. When interacted with, the return button displays the task page. To approve the selected task, the second party may interact with the approve button, which displays the task page and moves the selected task entry to the assigned tab. If a task entry was selected from the pending tab, then graphical user interface 905 would display an assign button in place of the approve button. The assign button would prompt the second party to select a first party to assign the selected task to. Additionally, graphical user interface 905 would display an options button in place of the return button. The options button would display a pop up menu with at least two options including edit the task and delete the task.

The task page further includes a plus sign icon 952 that is configured to display graphical user interface 906 illustrated in FIG. 9F. Graphical user interface 906 is also displayed when the first party interacts with the plus sign icon in graphical user interface 806 in FIG. 8G. Graphical user interface 906 includes a template icon 960 and a new procedure icon 962. Selecting the new procedure icon would display the task generator graphical user interface. The task generator graphical user interface allows the second party to enter task data, similar to graphical user interface 807 in FIG. 8H, including a first party. Selecting the template icon 960 would generate a task from a saved or favorited template. Once a task is created in the task generator graphical user interface, graphical user interface 907 is displayed. Shown in FIG. 9G, graphical user interface 907 includes a summary of the generated task 964 and its associated task data 965. The second party can assign the newly generated task to the first party added in the task data by interacting with the assign task button 966 on graphical user interface 907. Additionally, before assigning the task, the second party may interact with the favorite button 968 to save the generated task as a template or favorite. The favorite button includes an icon in the shape of a star. However, other icons or shapes may be used and are within the spirit and scope of the present disclosure.

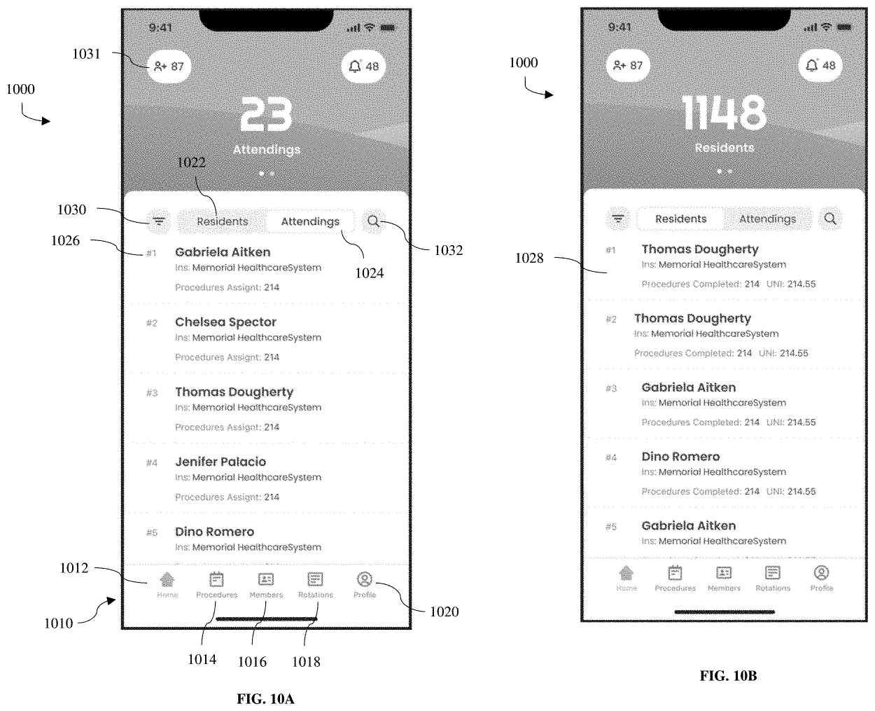

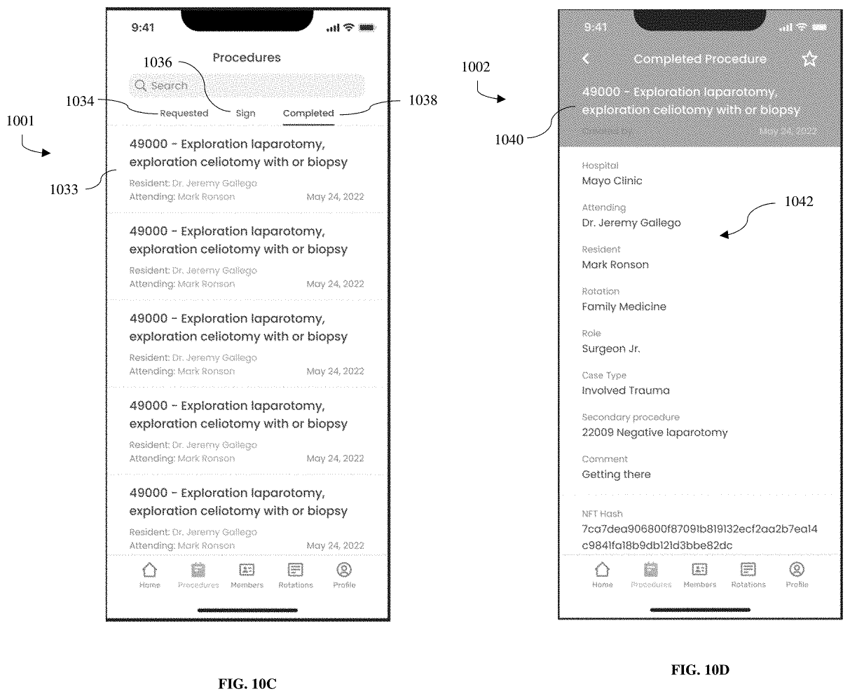

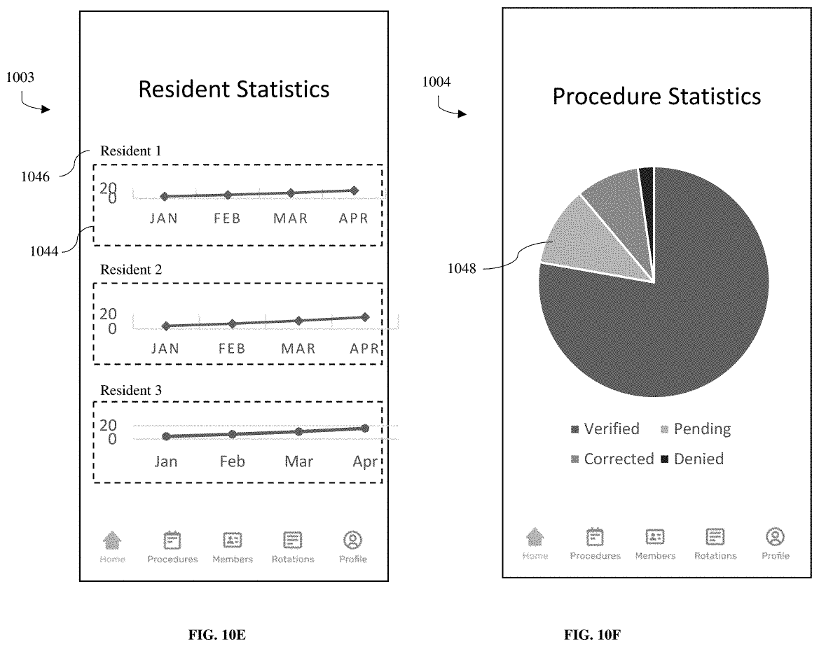

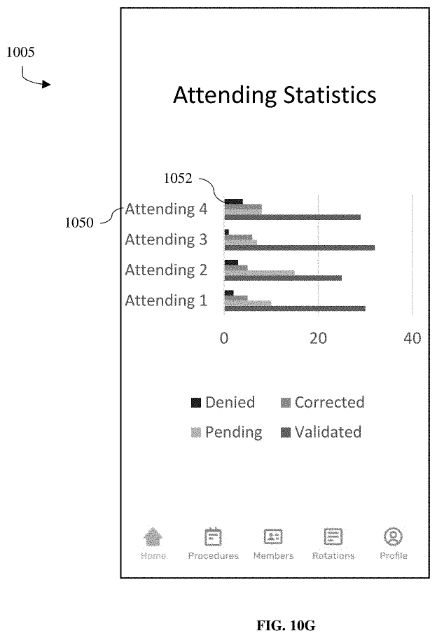

Referring now to FIGS. 10A through 10G, illustrations of a graphical user interface for each of a plurality of pages configured to be displayed on the third computing device is shown, according to an example embodiment. FIGS. 10A and 10B illustrates a graphical user interface 1000 of a home page configured to be displayed on a third party computing device, according to an example embodiment. Graphical user interface includes a page bar 1010 including a home page icon 1012, task page icon 1014, members page icon 1016, rotations page icon 1018, and a profile page icon 1020. The third party can interact with any of the page icons to open a corresponding page. The home page includes a first party tab 1022 and a second party tab 1024. When the second party tab is selected, a list of first party entries 1026 are displayed. When the first party tab is selected, a list of first party entries 1028 are displayed as shown in FIG. 10B. The third party can filter the list of entries by interacting with the filter button 1030 to display a pop up menu with a plurality of filtering options. Alternatively, the third party can interact with the search icon 1032 to search for a specific entry. Graphical user interface 1000 further includes an icon 1031 that displays the number of first parties and second parties affiliated with the third party. When interacted with, the members page icon displays the members page, which includes a list of first parties and second parties affiliated with the third party. The members page is categorized by first parties, second parties, and users waiting to be affiliated with the third party.

FIG. 10C illustrates a graphical user interface 1001 of a task page configured to be displayed on the third computing device. Graphical user interface 1001 includes a list of task entries 1033 generated by the first parties and second parties affiliated with the third party. The task entries are categorized into different tabs including a requested task tab 1034, a signed task tab 1036, and a completed task tab 1038. The third party may select a task by interacting with a task entry 1033 to display graphical user interface 1002 illustrated in FIG. 10D. Graphical user interface 1002 includes a completed task record 1040 associated with selected task entry and the plurality of attributes 1042 of the completed task record 1040.

FIGS. 10E through 10G illustrate graphical user interfaces of a home page including statistics for first party performance, tasks, and second party performance, according to an example embodiment. Graphical user interface 1003 in FIG. 10E includes statistics of a plurality of first parties affiliated with the third party. Graphical user interface 1003 includes a line graph 1044 for each of the first party entries 1046. The x-axis of the line graph is a period of time, such as a specific month, and the y-axis of the line graph is the number of validated completed tasks. Each line graph is configured to depict the performance of the corresponding first party to help analyze the progress of the first party. In other embodiments, different graph types or graphical representations configured to illustrate a first party's performance over time may be used and are within the spirit and scope of the present invention. FIG. 10F illustrates a graphical user interface 1004 configured to display the statistics of tasks performed by members of the third party. The graphical user interface 1004 includes a pie chart 1048 to allow the third party to analyze the status of tasks. The pie chart includes data for validated tasks, pending tasks, corrected tasks, and denied tasks. In other embodiments, different graph types or graphical representations configured to illustrate the status statistics of tasks may be used and are within the spirit and scope of the present invention. FIG. 10G illustrates a graphical user interface 1005 configured to display the statistics of a plurality of second parties. For each of the second party entries 1050, a corresponding bar graph 1052 illustrates the number of tasks per second party response to a completed task record. The x-axis of the bar graphs is the number of tasks. The y-axis is the name of the second party. The second party's responses are categorized into denials, corrections, pendings, and validations. In other embodiments, different graph types or graphical representations configured to illustrate the statistics of a second party's responses to completed task records may be used and are within the spirit and scope of the present invention.

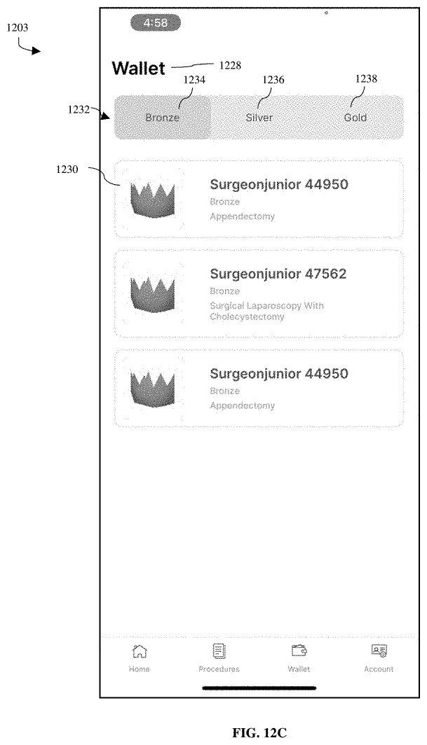

Referring now to FIG. 12A, a diagram illustrating a graphical user interface 1201, or user interface, including a list of procedures configured to be displayed on a computing device shown, according to an example embodiment. The first party interface may be displayed on a first computing device 111. The first party interface may include procedures entries 1204. The procedure entries represent the cases associated with the first party. The procedures entries may include the procedure name 1206, name of attending that assigned the procedure 1208, and the assigned date 1210. The first party interface may include an assigned tab 1212, a completed tab 1214, and a pending tab 1216. The first party may click on the assigned tab to view a list of assigned procedures. The first party may click on the completed tab to view a list of completed procedures. The first party may click on the pending tab to view a list of requested procedures that are awaiting approval from the second party. The first party interface may also include a button 1219 that the first party may click on to request a procedure.

Referring now to FIG. 12B, a diagram illustrating a graphical user interface 1202, or user interface, including a procedure report configured to be displayed on a computing device shown, according to an example embodiment. The first party interface includes a graphical representation of a monthly procedure report 1220. The monthly procedure report may track the number of procedures completed by the first party. The first party interface may include a list of received NFTs 1222. Each entry in the list may include the NFT 1224, which is a graphical representation of the token in the blockchain. The entries may also include the date 1226 that the NFT was received.

Referring now to FIG. 12C, a diagram illustrating a graphical user interface 1203, or user interface, including a wallet and a plurality of tokens configured to be displayed on a computing device is shown, according to an example embodiment. The first party interface may be displayed on a first computing device 111. The first party interface may include the second graphical representation of the wallet 1228 that includes the graphical representations of the plurality of tokens 1230. The first party interface may include a graphical bar 1232 comprising a tab for bronze 1234, silver 1236, and gold 1238. Each of the tabs allow the first party to view bronze tokens, silver tokens, and gold tokens, respectively.

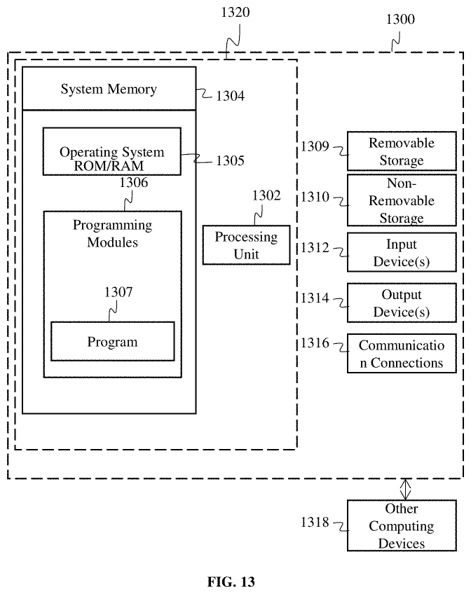

FIG. 13 is a block diagram of a system including an example computing device 1300 and other computing devices. Consistent with the embodiments described herein, the aforementioned actions performed by devices 106, 111, 131, 131 may be implemented in a computing device, such as the computing device 1300 of FIG. 13. Any suitable combination of hardware, software, or firmware may be used to implement the computing device 1300. The aforementioned system, device, and processors are examples and other systems, devices, and processors may comprise the aforementioned computing device. Furthermore, computing device 1300 may comprise an operating environment for systems 100 and processes 400, 500, 600 and other described herein, providing data related to data flow 200 and GUIS illustrated in FIG. 5 described above. Processes 400, 500, 600 and other described herein, data related to data flow 200 and other described herein, and GUI illustrated in FIG. 7A and others described herein may operate in other environments and are not limited to computing device 1300.

With reference to FIG. 13, a system consistent with an embodiment of the invention may include a plurality of computing devices, such as computing device 1300. In a basic configuration, computing device 1300 may include at least one processing unit 1302 and a system memory 1304. Depending on the configuration and type of computing device, system memory 1304 may comprise, but is not limited to, volatile (e.g., random access memory (RAM)), non-volatile (e.g., read-only memory (ROM)), flash memory, or any combination or memory. System memory 1304 may include operating system 1305, and one or more programming modules 1306. Operating system 1305, for example, may be suitable for controlling computing device 1300's operation. In one embodiment, programming modules 1306 may include, for example, a program module 1307 for executing the actions of devices 106, 111, 131, 131, for example. Furthermore, embodiments of the invention may be practiced in conjunction with a graphics library, other operating systems, or any other application program and is not limited to any particular application or system. This basic configuration is illustrated in FIG. 7 by those components within a dashed line 1320.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 6 by a removable storage 1309 and a non-removable storage 1310. Computer storage media may include volatile and nonvolatile, removable and non-removable media implemented in any method or technology for storage of information, such as computer readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a camera, a touch input device, etc. Output device(s) 1314 such as a display, speakers, a printer, etc. may also be included. The aforementioned devices are only examples, and other devices may be added or substituted.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 1304, including operating system 1305. While executing on processing unit 1302, programming modules 1306 (e.g., program module 1307) may perform processes including, for example, one or more of the stages of the methods 400, 500, 600 as described above. The aforementioned processes are examples, and processing unit 1302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer implemented method for determining a veracity of a completed task for validating the completed task towards a progression of a goal, wherein the completed task is a medical procedure performed by a first party, wherein the goal is to compile a predetermined number of completed tasks required by a third party, wherein the computer implemented method being executed by one or more processors, the computer implemented method comprising:
a. receiving first party registration data for generating a first party user record, wherein the first party registration data comprises a first unique identifier associated with the first party and wherein such first party registration data is input on a first computing device associated with the first party;
b. receiving second party registration data for generating a second party user record, wherein the second party registration data comprises a second unique identifier associated with a second party and wherein such second party registration data is input on a second computing device associated with the second party;
c. receiving third party registration data for generating a third party user record, wherein the third party registration data comprises unique task requirements associated with the third party and wherein such third party registration data is input on a third computing device associated with the third party;
d. storing the first party user record, the second party user record, and the third party user record in a connected database;
e. receiving, prior to determining the veracity of the completed task, at a direction of the first party, task data from the first computing device to generate a completed task record, the task data comprising a plurality of attributes of the completed task;
f. concurrently to receiving task data, receiving real-time input data automatically generated from the first computing device to generate a time stamp associated with an entry of the task data, the real-time input data comprising a date, time, and geolocation of the entry of the task data on the first computing device;
g. determining if the time stamp is within a predetermined period of time after the completed task was performed, wherein the predetermined period of time is based on the task data;
h. after determining that the completed task was performed within the predetermined period of time, causing an SMS message to be sent to the second computing device of the second party to determine the veracity of the completed task, the SMS message comprising (i) at least a portion of the first party user record, (ii) the completed task record, and (iii) a solicitation to approve the completed task record;
i. receiving a reply SMS message from the second computing device, the reply SMS message comprising veracity data that defines an approval or a disapproval of the completed task record;
j. after determining that the approval was received, then generating a validated task record based on the reply SMS message;
k. storing the validated task record on a blockchain network; and
l. minting a token associated with the validated task.

2. The computer implemented method of claim 1 comprising sending the token to the first computing device of the first party.

3. The computer implemented method of claim 2, comprising, after generating the validated task record, then generating a numerical score for the validated task record based on a plurality of predetermined scoring metrics.

4. The computer implemented method of claim 3, comprising, after generating a numerical score for the validated task record, then calculating a user score based on the numerical score of the validated task record.

5. The computer implemented method of claim 4 comprising generating a progress interface for displaying a progression status indicator on the first computing device, wherein generating the progress interface comprises generating a progression level towards the goal based on comparing the validated task record to the unique task requirements of the third party record.

6. The computer implemented method of claim 5 comprising creating a plurality of tokens for a plurality of validated task records.

7. The computer implemented method of claim 6 comprising tracking progression towards the goal by continuously updating the progression status indicator on the first computing device, wherein updating the progression status indicator comprises generating an updated progression level after processing each validated task record of the plurality of validated task records and generating an updated progress interface to be displayed on the first computing device.

8. The computer implemented method of claim 7 comprising updating the user score based on calculating an updated user score, the updated user score being based on processing each validated task record of the plurality of validated task records.

9. The computer implemented method of claim 8 comprising generating an accreditation record for the first party when the goal is achieved, wherein achieving the goal comprises at least one of (i) the user score reaches a predetermined maximum user score; (ii) all unique task requirements of the third user record have been satisfied by the plurality of validated task records of the first party; and (iii) the progression level reaches a predetermined maximum progression level.

10. The computer implemented method of claim 9 comprising generating a graphical representation of the token for the validated task record based on at least one attribute of the plurality of attributes.

11. The computer implemented method of claim 10 comprising generating a second graphical representation of a wallet to be sent to the first computing device for displaying the graphical representation of the token.

12. The computer implemented method of claim 11 comprising categorizing a plurality of tokens based on a plurality of validated attributes of a plurality of validated tasks, the categorizing comprising a plurality of predetermined groups that each correspond to a specific attribute of the plurality of attributes.

13. The computer implemented method of claim 12 comprising after determining that the disapproval was received, then receiving revised task data from the second computing device, the revised task data comprising at least one change to at least one attribute of the plurality of attributes; and
then generating the validated task record based on the revised task data.

14. A computer implemented method for determining a veracity of a completed task for validating the completed task towards a progression of a goal, wherein the completed task is a medical procedure performed by a first party, wherein the goal is to compile a predetermined number of completed tasks required by a third party, wherein the computer implemented method being executed by one or more processors, the computer implemented method comprising:
a. receiving first party registration data for generating a first party user record, wherein the first party registration data comprises a first unique identifier associated with the first party and wherein such first party registration data is input on a first computing device associated with the first party;
b. receiving second party registration data for generating a second party user record, wherein the second party registration data comprises a second unique identifier associated with a second party and wherein such second party registration data is input on a second computing device associated with the second party;
c. receiving third party registration data for generating a third party user record, wherein the third party registration data comprises unique task requirements associated with the third party and wherein such third party registration data is input on a third computing device associated with the third party;
d. storing the first party user record, the second party user record, and the third party user record in a connected database;
e. receiving, prior to determining the veracity of the completed task, at a direction of the first party, task data from the first computing device to generate a completed task record, the task data comprising a plurality of attributes of the completed task;
f. concurrently to receiving task data, receiving real-time input data automatically generated from the first computing device to generate a time stamp associated with the entry of the task data, the real-time input data comprising a date, time, and geolocation of the entry of the task data on the first computing device;
g. causing a message to be sent to the second computing device of the second party to determine the veracity of the completed task, the message comprising (i) at least a portion of the first party user record, (ii) the completed task record, and (iii) a solicitation to approve the completed task record;
h. receiving a reply message from the second computing device, the reply message comprising veracity data that defines an approval or a disapproval of the completed task record;
i. after determining that the approval was received, then generating a validated task record based on the reply SMS message;
j. storing the validated task record on a blockchain network; and
k. minting a token associated with the validated task.

15. The computer implemented method of claim 14 comprising generating a graphical representation of the token for the validated task record based on at least one attribute of the plurality of attributes.

16. The computer implemented method of claim 14 comprising generating a plurality of tokens based on a plurality of validated tasks and then categorizing the plurality of tokens based on a plurality of validated attributes of the plurality of validated tasks into a plurality of predetermined groups, wherein each group correspond to a specific attribute of the plurality of validated attributes.

17. The computer implemented method of claim 15 comprising generating a third user graphical interface comprising aggregated data about at least one of the first party and the second party, the aggregated data comprising information about a respective party's performance over time.

18. The computer implemented method of claim 16 comprising, if the respective party's performance is below a predetermined threshold level of performance then at least one of (1) sending a performance message to the computing device of the respective party, the performance message comprising a performance metric of the respective party, and (2) sending an incentive message to the computing device of the respective party, the incentive message comprising a second set of goals to complete to receive an incentive.

19. The computer implemented method of claim 16 comprising determining if the time stamp is within a predetermined period of time after the completed task was performed, wherein the predetermined period of time is based on the task data.

20. A computer implemented method for determining a veracity of a medical case for validating the medical case towards a progression to an accreditation of at least one of a resident health professional and a medical institution, wherein the medical case is a medical procedure performed by the resident health professional, wherein the accreditation is achieved by compiling a predetermined number of medical cases required by at least one of the medical institution and an accrediting institution, wherein the computer implemented method being executed by one or more processors, the computer implemented method comprising:
a. receiving resident health professional registration data for generating a resident health professional user record, wherein the resident health professional registration data comprises a first unique identifier associated with the resident health professional and wherein such resident health professional registration data is input on a first computing device associated with the resident health professional;
b. receiving attending health professional registration data for generating an attending health professional user record, wherein the attending health professional registration data comprises a second unique identifier associated with an attending health professional and wherein such attending health professional registration data is input on a second computing device associated with the attending health professional;
c. receiving third party registration data for generating a third party user record, wherein the third party registration data comprises unique task requirements associated with the third party and wherein such third party registration data is input on a third computing device associated with the third party, and wherein the third party is at least one of a medical institution and an accrediting institution;
d. storing the resident health professional user record, the attending health professional user record, and the third party user record in a connected database;
e. receiving, prior to determining the veracity of the medical case, at a direction of the resident health professional, medical record data from the first computing device to generate a medical case record, the medical record data comprising a plurality of attributes of the medical case;
f. concurrently to receiving task data, receiving real-time input data automatically generated from the first computing device to generate a time stamp associated with the entry of the medical record data, the real-time input data comprising a date, time, and geolocation of the entry of the task data on the first computing device;
g. determining if the time stamp is within a predetermined period of time after the medical case was performed, wherein the predetermined period of time is based on the medical record data;
h. after determining that the medical case was performed within the predetermined period of time, causing an SMS message to be sent to the second computing device of the attending health professional to determine the veracity of the medical case, the SMS message comprising (i) at least a portion of the resident health professional user record, (ii) the medical case record, and (iii) a solicitation to approve the medical case record;
i. receiving a reply SMS message from the second computing device, the reply SMS message comprising veracity data that defines an approval or a disapproval of the medical case record;
j. after determining that the approval was received, then generating a validated medical case record based on the reply SMS message;
k. storing the validated medical case record on a blockchain network;
l. minting a token associated with the validated task;
m. generating a graphical representation of the token for the validated task record based on at least one attribute of the plurality of attributes;
n. generating a third user graphical interface for displaying on the third computing device, the third user graphical interface comprising aggregated data about the performance of the at least one of the resident health professional and the attending health professional over time, wherein the performance is measurable based on at least one of the number of medical cases and validated medical cases; and
o. if the respective party's performance is below a predetermined threshold level of performance, then at least one of (1) sending a performance message to the computing device of the respective party, the performance message comprising a performance metric of the respective party, and (2) sending an incentive message to the computing device of the respective party, the incentive message comprising a second set of goals to complete to receive an incentive.
